(19) United States
(12) Patent Application Publication
(10) Pub. No.: US 2021/0116342 A1
(43) Pub. Date: Apr. 22, 2021

(54) Mechanical performance testing device and hydraulic control system thereof

(71) Applicants: Jun Liu, Hefei (CN); Pengliang Yang, Hefei (CN); Runfeng Li, Hefei (CN); Rui Li, Hefei (CN); Haijian Zhang, Hefei (CN); Yaozhong Hu, Hefei (CN)

(72) Inventors: Jun Liu, Hefei (CN); Pengliang Yang, Hefei (CN); Runfeng Li, Hefei (CN); Rui Li, Hefei (CN); Haijian Zhang, Hefei (CN); Yaozhong Hu, Hefei (CN)

(21) Appl. No.: 16/658,033

(22) Filed: Oct. 19, 2019

(51) Int. Cl. G01N 3/10; G01N 3/22; G01N 3/20; F15B 7/06

(52) U.S. Cl. CPC G01N 3/10; F15B 7/06; G01N 3/20; G01N 3/22

(57) ABSTRACT

The invention discloses a mechanical performance testing device and a hydraulic control system thereof. The instrument comprises a base, a fixing means, a first testing means and a second testing means. Wherein the base is connected with the fixing means, each of the first testing means and the second testing means is configured to cause the fixing means to move in various directions. And the instrument can simultaneously apply multiple forces and torques on the element, such that the different stiffness characteristics of the element can be tested simultaneously. The hydraulic control system comprises fuel tank, oil pump and control valves. And the fuel tank, the oil pump and the control valves connect successively. The mechanical performance testing device with hydraulic control system can improve efficiency of the test, reduce the working intensity of inspector, increase the security in detection process, and improve the accuracy of measurement results.

### FIELD

The subject matter generally relates to analysis and measurement engineering, and more particularly to a mechanical performance testing device and hydraulic control system thereof.

### BACKGROUND

Stiffness characteristic and quality are very important for the products, and even affect the quality of the products directly. Elastic bearing is one of the three technologies of the third generation of rotor system and an important component of rotor system. Therefore, the stiffness and quality of elastic bearings are very important to the flight performance and safety of helicopters, and directly affect the quality and sales of helicopters. Therefore, it is necessary to accurately detect the stiffness characteristics of elastic bearings before use. However, multiple forces and torques should be applied on the elastic bearing to measure the stiffness characteristics, and at the state of the art, different property of the elastic bearing generally tested by different devices, this results in low detection efficiency, high working intensity, low degree of safety, low detection precision.

### SUMMARY OF INVENTION

An aspect of the present invention is directed to a mechanical performance testing device. The device comprises a base, a fixing means, a first testing means and a second testing means. Wherein the base is connected with the fixing means, each of the first testing means and the second testing means is configured to cause the fixing means to move in various directions.

In some embodiments, the base comprises a pedestal and a rotation axle, the pedestal is provided with a shaft block, one end of the rotation axle is installed on the shaft block by a thrust bearing, the other end of the rotation axle is connected with the fixing means, and the first testing means is connected with the rotation axle.

In some embodiments, the fixing means comprises a first fixing platform and a second fixing platform, the first fixing platform is in cooperation with the second fixing platform to form a fixing cavity and the fixing cavity is used to fix the element to be tested, one side of the first fixing platform away from the second fixing platform is provided with a first spline shaft, the first fixing platform is connected in a transmission way with the rotation axle through the first spline shaft, and the second fixing platform is connected with the second testing means.

In some embodiments, one side of the second fixing platform away from the first fixing platform is provided with a second spline shaft, and the second fixing platform is connected in a transmission way with the second testing means through the second spline shaft.

In some embodiments, the fixing means also comprises a locking means, the locking means cooperates with the first testing means to implement a measurement of the torsional stiffness property, the locking means comprises a first locking hydraulic cylinder and a second locking hydraulic cylinder, with the first locking hydraulic cylinder and the second locking hydraulic cylinder being installed symmetrically on two sides of the second fixing platform for fixing the second fixing platform.

In some embodiments, the first testing means comprises a torsional testing unit, the torsional testing unit cooperates with the locking means to implement the measurement of the torsional stiffness property, the torsional testing unit comprises a turnplate and a twisting hydraulic cylinder, with the turnplate being installed on the rotation axle and being configured to be coaxial with the rotation axle, and with the twisting hydraulic cylinder being configured to apply torque on the turnplate for driving the rotation axle to perform torsional stiffness characteristic tests on the test element.

In some embodiments, the first testing means comprises a torsional testing unit, the torsional testing unit cooperates with the locking means to implement the measurement of the torsional property, the torsional testing unit comprises a turnplate, a first twisting hydraulic cylinder and a second twisting hydraulic cylinder, with the turnplate being installed on the rotation axle and being configured to be coaxial with the rotation axle, both of the first twisting hydraulic cylinder and the second twisting hydraulic cylinder apply torque on the turnplate to drive the rotation axle to perform torsional stiffness characteristic tests on the test element.

In some embodiments, wherein the second testing means comprises a bending testing unit, the bending testing unit is installed on the second fixing platform and can be configured to drive the second fixing platform to move in a preset direction to test the bending stiffness characteristics of the test element.

In some embodiments, the bending testing unit comprises a first bending hydraulic cylinder and a second bending hydraulic cylinder. The stretching direction of the first bending hydraulic cylinder and the stretching direction of the second bending hydraulic cylinder are mutually perpendicular, both of the two stretching directions are both perpendicular to the axial direction of the rotation axle. The second fixing platform can be driven by the first bending hydraulic cylinder and/or the second bending hydraulic cylinder to move in preset direction to realize the measurement of bending stiffness in different directions of the element. The first bending hydraulic cylinder and the second bending hydraulic cylinder can simultaneously drive the second fixing platform to move in a preset direction, so as to simultaneously test the bending stiffness in two directions of the element to be tested. Users can make the first bending hydraulic cylinder or the second bending hydraulic cylinder drive the second fixing platform to move in a preset direction, so as to test the bending stiffness in the corresponding direction of the element to be tested.

In some embodiments, the bending testing unit also comprises a mounting part, the first bending hydraulic cylinder and the second bending hydraulic cylinder both being installed on the mounting part, the mounting part and the second fixing platform are connected through the second spline shaft in a transmission way.

In some embodiments, the mounting part is provided with a first installation groove and a second installation groove. The first bending hydraulic cylinder connects with the mounting part by a first adapting piece, one end of the first adapting piece near the mounting part is located in the first installation groove. The second bending hydraulic cylinder connects with the mounting part by a second adapting piece, one end of the second adapting piece near the mounting part is located in the second installation groove. Along the axial direction of the rotation axle, the length of the first installation groove is greater than the length of the first adapting piece, the length of the second installation groove is greater than the length of the second adapting piece, so that can prevent the first adapting piece, the second adapting piece and the mounting part from influencing each other during the test. With the existence of the first installation groove, the bending stiffness of element in the directions of stretching out and drawing back of the first bending hydraulic cylinder can be measured. With the existence of the second installation groove, the bending stiffness of element in the directions of stretching out and drawing back of the second bending hydraulic cylinder can be measured.

In some embodiments, the second testing means also comprises a compression testing unit, the compression testing unit comprises a compressing hydraulic cylinder, one side of the mounting part away from the second fixing platform is connected with the compressing hydraulic cylinder through a flange.

Another aspect of the present invention is directed to a hydraulic control system applied to the mechanical performance testing device. The system comprises a fuel tank, an oil pump and a control valves, and the fuel tank, the oil pump and the control valves connect successively. The fuel tank and oil pump cooperate to supply oil. The control valves are used to control the extend-retract of the compressing hydraulic cylinder, the control valves are used to control the extend-retract of the first bending hydraulic cylinder, the control valves are used to control the extend-retract of the second bending hydraulic cylinder, the control valves are used to control the extend-retract of the first twisting hydraulic cylinder and the second twisting hydraulic cylinder, the control valves are used to control the extend-retract of the first locking hydraulic cylinder and the second locking hydraulic cylinder.

In some embodiments, the control valves comprise a check valve, a 2-position 3-way magnetic exchange valve, a first 2-position 2-way magnetic exchange valve and a first 2-position 4-way magnetic exchange valve, the oil pump, the check valve and the 2-position 3-way magnetic exchange valve connect successively, the 2-position 3-way magnetic exchange valve, the first 2-position 2-way magnetic exchange valve, the first 2-position 4-way magnetic exchange valve and the compressing hydraulic cylinder connect successively, the first 2-position 4-way magnetic exchange valve is used to control the extend-retract of the compressing hydraulic cylinder, the first 2-position 4-way magnetic exchange valve and the fuel tank are connected through a first oil return pipe.

In some embodiments, an overflow valve is installed on the outlet pipe of the check valve. The overflow valve is used to protect the hydraulic control system from potential safety hazard due to the pressure of hydraulic control system is too large.

In some embodiments, the control valves also comprise a second 2-position 2-way magnetic exchange valve and a second 2-position 4-way magnetic exchange valve, the 2-position 3-way magnetic exchange valve, the second 2-position 2-way magnetic exchange valve, the second 2-position 4-way magnetic exchange valve and the first bending hydraulic cylinder connect successively, the second 2-position 4-way magnetic exchange valve is used to control the extend-retract of the first bending hydraulic cylinder, the second 2-position 4-way magnetic exchange valve and the fuel tank are connected through a second oil return pipe.

In some embodiments, the control valves also comprise a third 2-position 2-way magnetic exchange valve and a third 2-position 4-way magnetic exchange valve, the 2-position 3-way magnetic exchange valve, the third 2-position 2-way magnetic exchange valve, the third 2-position 4-way magnetic exchange valve and the second bending hydraulic cylinder connect successively, the third 2-position 4-way magnetic exchange valve is used to control the extend-retract of the second bending hydraulic cylinder, the third 2-position 4-way magnetic exchange valve and the fuel tank are connected through a third oil return pipe.

In some embodiments, the control valves also comprise a fourth 2-position 2-way magnetic exchange valve and a fourth 2-position 4-way magnetic exchange valve, the 2-position 3-way magnetic exchange valve, the fourth 2-position 2-way magnetic exchange valve and the fourth 2-position 4-way magnetic exchange valve connect successively, the first locking hydraulic cylinder and the second locking hydraulic cylinder both connect with the fourth 2-position 4-way magnetic exchange valve, the fourth 2-position 4-way magnetic exchange valve is used to control the extend-retract of the first locking hydraulic cylinder and the second locking hydraulic cylinder simultaneously, the fourth 2-position 4-way magnetic exchange valve and the fuel tank are connected through a fourth oil return pipe.

In some embodiments, the control valves also comprise a non-return valve group controlled by hydraumatic, the first locking hydraulic cylinder and the second locking hydraulic cylinder both connect with the fourth 2-position 4-way magnetic exchange valve through the non-return valve group, the non-return valve group is used to control the extend-retract of the first locking hydraulic cylinder and the second locking hydraulic cylinder simultaneously.

In some embodiments, the control valves also comprise a fifth 2-position 2-way magnetic exchange valve and a fifth 2-position 4-way magnetic exchange valve, the 2-position 3-way magnetic exchange valve, the fifth 2-position 2-way magnetic exchange valve and the fifth 2-position 4-way magnetic exchange valve connect successively, the first twisting hydraulic cylinder and the second twisting hydraulic cylinder both connect with the fifth 2-position 4-way magnetic exchange valve, the fifth 2-position 4-way magnetic exchange valve is used to control the extend-retract of the first twisting hydraulic cylinder and the second twisting hydraulic cylinder simultaneously, the fifth 2-position 4-way magnetic exchange valve and the fuel tank are connected through a fifth oil return pipe.

The present invention have at least the following advantages or beneficial effects:

The invention discloses a mechanical property testing instrument. The instrument comprises a base, a fixture connected with the base, a first testing device and a second testing device. The base is used to fix the instrument. The fixture is used to fix the elastic bearing. The first testing means and the second testing means are respectively used to make the fixing means move in different directions so that the different deformation characteristics of the element to be tested can be measured separately. And the instrument can simultaneously apply multiple forces and torques on the element, such that the different deformation characteristics of the element can be tested simultaneously.

The invention discloses a hydraulic control system which can be applied to the mechanical property testing instrument. The system comprises fuel tank, oil pump and control valves, and the fuel tank, the oil pump and the control valves connect successively. The fuel tank and oil pump cooperate to supply oil. The control valves are used to control the extend-retract of the compressing hydraulic cylinder. The control valves are used to control the extend-retract of the first bending hydraulic cylinder. The control valves are used to control the extend-retract of the second bending hydraulic cylinder. The control valves are used to control the extend-retract of the first twisting hydraulic cylinder and the second twisting hydraulic cylinder. The control valves are used to control the extend-retract of the first locking hydraulic cylinder and the second locking hydraulic cylinder. The hydraulic control system can improve efficiency of the test, reduce the working intensity of inspector, increase the security in detection process, and improve the accuracy of measurement results.

### BRIEF DESCRIPTION OF THE DRAWINGS

Implementations of the present technology will now be described, by way of example only, with reference to the attached figures. These and other aspects of the subject invention will become readily apparent to those of ordinary skill in the art from the following detailed description together with the drawings.

FIG. 1 is a structure diagram of a mechanical performance testing device in accordance with an exemplary embodiment of the present disclosure.

FIG. 2 is a schematic view of decomposition structure of a base and a first testing means, in accordance with an exemplary embodiment of the present disclosure.

FIG. 3 is a schematic view of decomposition structure of a base, a fixing means and a second testing means, in accordance with an exemplary embodiment of the present disclosure.

FIG. 4 is a structure diagram of an elastic bearing clamped by a fixing means, in accordance with an exemplary embodiment of the present disclosure.

FIG. 5 is an A-direction view in FIG. 2 in accordance with an exemplary embodiment of the present disclosure.

FIG. 6 is a structure diagram of a second testing means in accordance with an exemplary embodiment of the present disclosure.

FIG. 7 is a structure diagram of a bending testing unit in accordance with an exemplary embodiment of the present disclosure.

FIG. 8 is a control schematic diagram of a hydraulic control system during loading which has simultaneously began to test the torsional stiffness characteristics of an elastic bearing around the X-axis, bending stiffness characteristics in the direction of the Y-axis, bending stiffness characteristics in the direction of the Z-axis and compression stiffness characteristics in the direction of the X-axis, in accordance with an exemplary embodiment of the present disclosure.

FIG. 9 is a control schematic diagram of a hydraulic control system during unloading which has simultaneously accomplished testing the torsional stiffness characteristics of an elastic bearing around the X-axis, bending stiffness characteristics in the direction of the Y-axis, bending stiffness characteristics in the direction of the Z-axis and compression stiffness characteristics in the direction of the X-axis, in accordance with an exemplary embodiment of the present disclosure.

FIG. 10 is a control schematic diagram of a hydraulic control system which has began to test the compression stiffness characteristics of an elastic bearing in the direction of the X-axis, in accordance with an exemplary embodiment of the present disclosure.

FIG. 11 is a control schematic diagram of a hydraulic control system which has began to withdraw the force on the elastic bearing in the direction of the X-axis, in accordance with an exemplary embodiment of the present disclosure.

FIG. 12 is a control schematic diagram of a hydraulic control system which has began to test the bending stiffness characteristics of an elastic bearing in the direction of the Y-axis, in accordance with an exemplary embodiment of the present disclosure.

FIG. 13 is a control schematic diagram of a hydraulic control system which has began to withdraw the force on the elastic bearing in the direction of the Y-axis, in accordance with an exemplary embodiment of the present disclosure.

FIG. 14 is a control schematic diagram of a hydraulic control system which has began to test the bending stiffness characteristics of an elastic bearing in the direction of the Z-axis, in accordance with an exemplary embodiment of the present disclosure.

FIG. 15 is a control schematic diagram of a hydraulic control system which has began to withdraw the force on the elastic bearing in the direction of the Z-axis, in accordance with an exemplary embodiment of the present disclosure.

FIG. 16 is a control schematic diagram of a hydraulic control system which has began to test the torsional stiffness characteristics of an elastic bearing around the X-axis, in accordance with an exemplary embodiment of the present disclosure.

FIG. 17 is a control schematic diagram of a hydraulic control system which has began to withdraw the force on the elastic bearing around the X-axis, in accordance with an exemplary embodiment of the present disclosure.

Icons: 100—mechanical performance testing device; 110—base; 112—pedestal; 113—shaft block; 114—rotation axle; 115—first splined hole; 120—fixture; 121—first spline shaft; 122—first fixing platform; 123—fixing cavity; 124—second fixing platform; 125—second spline shaft; 126—locking means; 127—first bolt; 128—first locking hydraulic cylinder; 129—bar block; 130—second locking hydraulic cylinder; 131—second bolt; 140—first testing means; 141—first laser displacement sensor; 142—torsional testing unit; 143—first torsion connecting rod; 144—turnplate; 145—first displacement sensor; 146—first twisting hydraulic cylinder; 147—second torsion connecting rod; 148—second twisting hydraulic cylinder; 149—second displacement sensor; 160—second testing means; 161—first bend connecting rod; 162—bending testing unit; 163—second connecting rod; 164—first bending hydraulic cylinder; 165—first bending force transducer; 166—second bending hydraulic cylinder; 167—third bend connecting rod; 168—mounting part; 169—forth bend connecting rod; 170—first installation groove; 171—second bending force transducer; 172—second installation groove; 173—second laser displacement sensor; 175—third laser displacement sensor; 182—compression testing unit; 183—compression connecting rod; 184—compressing hydraulic cylinder; 185—pressure sensor; 187—forth laser displacement sensor; 200—hydraulic control system; 202—fuel tank; 204—oil pump; 212—check valve; 213—overflow valve; 214—2-position 3-way magnetic exchange valve; 222—first 2-position 2-way magnetic exchange valve; 224—first 2-position 4-way magnetic exchange valve; 232—second 2-position 2-way magnetic exchange valve; 234—second 2-position 4-way magnetic exchange valve; 242—third 2-position 2-way magnetic exchange valve; 244—third 2-position 4-way magnetic exchange valve; 252—fourth 2-position 2-way magnetic exchange valve; 253—first hydraulic control one-way valve; 254—fourth 2-position 4-way magnetic exchange valve; 255—second hydraulic control one-way valve; 256—hydraulic control one-way valve groups; 257—third hydraulic control one-way valve; 259—fourth hydraulic control one-way valve; 262—fifth 2-position 2-way magnetic exchange valve; 264—fifth 2-position 4-way magnetic exchange valve.

### DETAILED DESCRIPTION

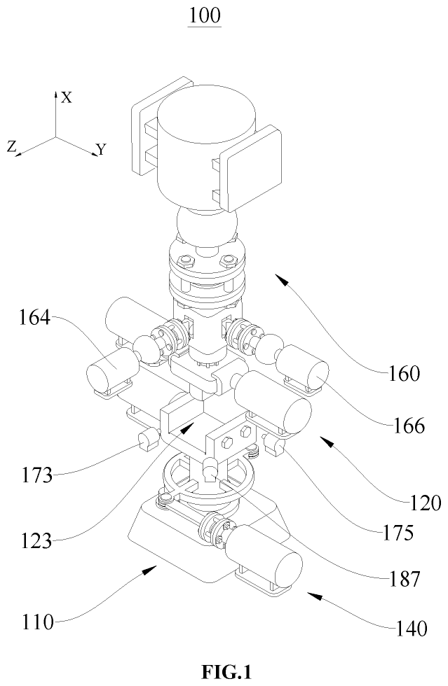

FIG. 1 illustrates a mechanical performance testing device 100, which includes a base 110, a fixing means 120 connected with the base, a first testing means 140 and a second testing means 160. The first testing means 140 and the second testing means 160 are respectively used to make the fixing means 120 move in different directions so that the different deformation characteristics of the elastic bearing to be tested can be measured separately.

Elastic bearing is one of the three technologies of the third generation of rotor system and an important component of rotor system. Therefore, the stiffness and quality of elastic bearings are very important to the flight performance and safety of helicopters, and directly affect the quality and sales of helicopters. Therefore, it is necessary to accurately detect the stiffness characteristics of elastic bearings before use. However, multiple forces and torques should be applied on the elastic bearing to measure the stiffness characteristics, and at the state of the art, different property of the elastic bearing generally tested by different devices, this results in low detection efficiency, high working intensity, low degree of safety, low detection precision. In one embodiment illustrated in FIG. 1, the mechanical performance testing device 100 can be used to measure different stiffness characteristics of an elastic bearing, or simultaneously apply multiple forces and torques on an elastic bearing, such that the different deformation characteristics of the elastic bearing can be tested simultaneously. In some embodiments, the mechanical performance testing device 100 may also be applied to the testing of other element to be tested.

It is should be noted that most structures mentioned in this embodiment need to be installed with the help of external fixed supports, to ensure the stability in the testing process of the mechanical performance testing device 100. The fixed supports can connect with the structures in any ways, for example welding. The user may choose suitable fixed supports according to different requirements, to provide suitable installation space for the structures.

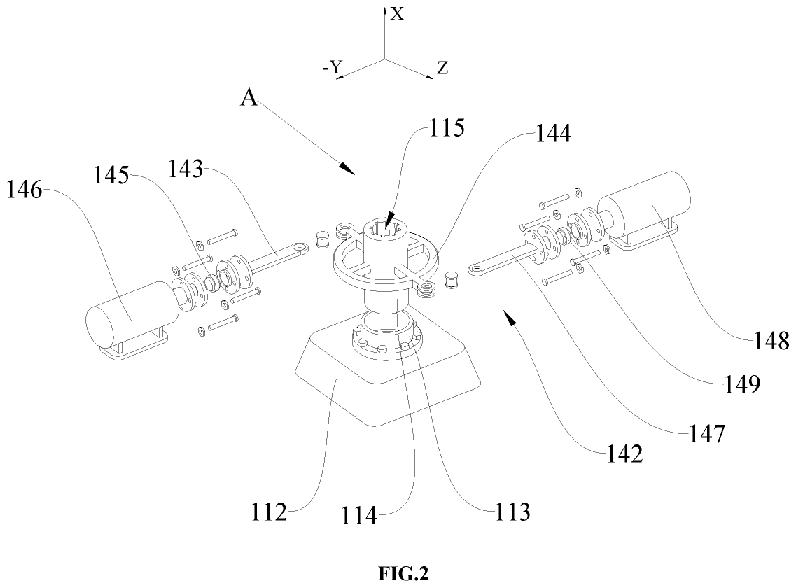

FIG. 2 illustrates a schematic view of decomposition structure of a base 110 and a first testing means 140. The base 110 includes a pedestal 112 and a rotation axle 114. The pedestal 112 is fixed on an installation plane (such as the ground) and has sufficient intensity, to ensure the safety during the test and the stability of the test results.

The pedestal 112 comprises a shaft block 113, one end of the rotation axle 114 being installed on the shaft block 113 by a thrust bearing. The other end of the rotation axle 114 is provided with a first splined hole 115. The rotation axle 114 connects with the fixing means 120 through the first splined hole 115. The rotation axle 114 is coaxial with the X axis.

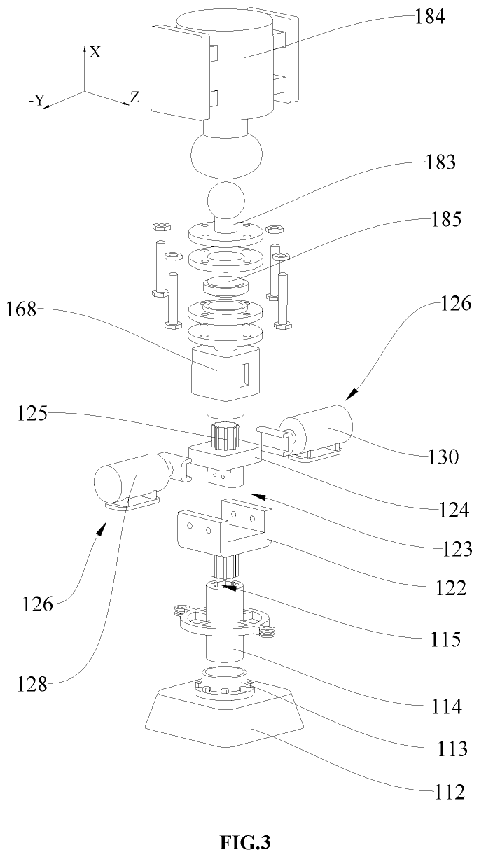

FIG. 3 illustrates a schematic view of decomposition structure of a base 110, a fixing means 120 and a second testing means 160. The fixing means 120 comprises a first fixing platform 122 and a second fixing platform 124, the first fixing platform 122 is in cooperation with the second fixing platform 124 to form a fixing cavity 123. The fixing cavity 123 is used to fix the elastic bearing. The first fixing platform 122 and the rotation axle 114 are connected in a transmission way, the second fixing platform 124 being connected with the second testing means 160.

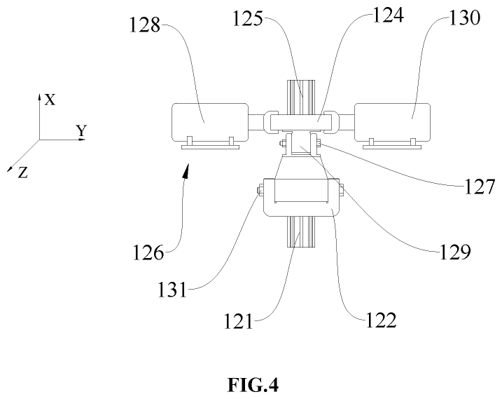

As illustrated in FIG. 3 and FIG. 4, FIG. 4 illustrates a structure diagram of an elastic bearing clamped by the fixing means 120. The elastic bearing has a square shape at the bottom, a frustum of a cone shape at the waist and a U-shape groove at the top. The frustum of a cone is coaxial with the X axis after the elastic bearing being clamped. In this embodiment, the first fixing platform 122 is a U-shape part for matching with the elastic bearing. In some embodiments, the shape of a first fixing platform 122 depends on the shape of the element to be tested. Both sides of the first fixing platform 122 are provided with through-hole (not marked in FIG. 3). The position of the through-hole corresponds to the hole on the elastic bearing. The through-hole can be used to installed a first bolt 127 to make the elastic bearing more steady. In some embodiments, the first fixing platform 122 may also be provided with no through-holes, as long as the fixation of the element to be test can be completed.

In this embodiment, a first spline shaft 121 is set on one side of the first fixing platform 122 away from the second fixing platform 124, the first spline shaft 121 is coaxial with the X axis. The first fixing platform 122 and the rotation axle 114 are in demountable connection by the cooperation of the first spline shaft 121 and the first splined hole 115, so that testers can choose different first fixing platform 122 according to different elastic bearing. In some embodiments, The first fixing platform 122 and the rotation axle 114 may be in demountable connection by other ways, as long as the first fixing platform 122 and the rotation axle 114 will not rotate relatively. Of course, in some embodiments, the first fixing platform 122 and the rotation axle 114 could be in permanent connection by such as glue joint or welding.

In this embodiment, due to the elastic bearing is provided with a U-shape groove at the top, so the second fixing platform 124 is T-shape. One side of the second fixing platform 124 near the first fixing platform 122 comprises a bar block 129 matching with the U-shape groove of the elastic bearing. In some embodiments, different second fixing platform 124 could be chosen according to different element to be tested. The bar block 129 has through holes (not marked in FIG. 3). The position of through holes on the bar block 129 corresponds to the position of holes on the elastic bearing. Holes on the bar block 129 can be used to installed a second bolt 131, the second bolt 131 will across the elastic bearing for fixing the elastic bearing, and the stability of the elastic bearing can be improved. In some embodiments, the second fixing platform 124 may also have no through holes, as long as the fixation of the element to be tested can be accomplished.

In this embodiment, a second spline shaft 125 is set on one side of the second fixing platform 124 away from the first fixing platform 122. The second spline shaft 125 and the X-axis are coaxial. The second fixing platform 124 and the second testing means 160 are in demountable connection through the second spline shaft 125, so that testers can choose different second fixing platform 124 according to different elastic bearing. In some embodiments, The second fixing platform 124 and the second testing means 160 may be in demountable connection by other ways. Of course, in some embodiments, the second fixing platform 124 and the second testing means 160 could be in permanent connection by such as glue joint or welding.

The fixing means 120 also comprises a locking means 126. In this embodiment, the locking means 126 and the first testing means 140 cooperate to measure the torsional stiffness characteristic around the X-axis of the elastic bearing. In this embodiment, the locking means 126 comprises a first locking hydraulic cylinder 128 and a second locking hydraulic cylinder 130. The first locking hydraulic cylinder 128 and the second locking hydraulic cylinder 130 are installed symmetrically on both sides of the second fixing platform 124, such that the second fixing platform 124 can be fixed. In this embodiment, the first locking hydraulic cylinder 128, the second locking hydraulic cylinder 130 and the second fixing platform 124 are at the same horizontal plane. The first locking hydraulic cylinder 128 and the second locking hydraulic cylinder 130 are coaxial. In some embodiments, the number of locking hydraulic cylinder may be other than two, as long as the second fixing platform 124 can be locked.

As illustrated in FIG. 2, the first testing means 140 comprises torsional testing unit 142. The torsional testing unit 142 and the locking means 126 cooperate to measure the torsional stiffness characteristic around the X-axis of the elastic bearing.

In this embodiment, the torsional testing unit 142 comprises turnplate 144, a first twisting hydraulic cylinder 146 and a second twisting hydraulic cylinder 148. The first twisting hydraulic cylinder 146 and the second twisting hydraulic cylinder 148 apply torque on the turnplate 144 together, to make the turnplate 144 be stressed uniformly and star to rotate. During the rotating, the turnplate 144 can basically stay coaxial with the X-axis, so that the accuracy of test results can be improved. The number of twisting hydraulic cylinder may be 3, 4, or other, as long as the turnplate 144 can basically stay coaxial with the X-axis during the rotating. The rotation of turnplate 144 will make the rotation axle 114 rotate, and the rotation axle 114 will make the first fixing platform 122 rotate, so that the torsional stiffness characteristic around the X-axis of the elastic bearing in the fixing cavity 123 can be measured. The turnplate 144 being installed on the rotation axle 114 and both of them are coaxial. In this embodiment, the turnplate 144 and the rotation axle 114 are molding in one. Of course, the turnplate 144 and the rotation axle 114 may connect in other ways, such as welding, clamping.

A pair of hinged holes (not marked in FIG. 2) are symmetrically arranged on the turnplate 144. The first twisting hydraulic cylinder 146 connects with the turnplate 144 by a first torsion connecting rod 143. One end of the first torsion connecting rod 143 connects with the piston of first twisting hydraulic cylinder 146 by a pair of ring flanges (not marked in FIG. 2), and the other end of the first torsion connecting rod 143 connects with the turnplate 144 through one of the hinged holes. A first displacement sensor 145 is installed between the ring flanges.

The second twisting hydraulic cylinder 148 connects with the turnplate 144 by a second torsion connecting rod 147. One end of the second torsion connecting rod 147 connects with the piston of second twisting hydraulic cylinder 148 by another pair of ring flanges (not marked in FIG. 2), and the other end of the second torsion connecting rod 147 connects with the turnplate 144 through another one of the hinged holes. A second displacement sensor 149 is installed between the ring flanges.

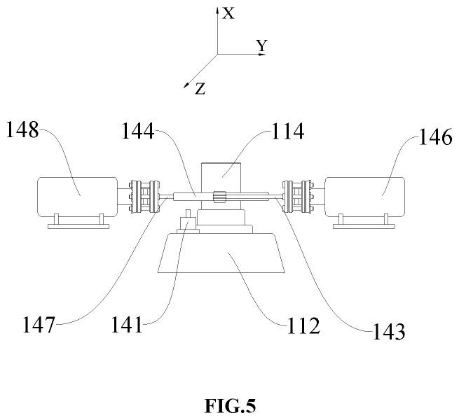

FIG. 5 illustrates an A-direction view in FIG. 2. A first laser displacement sensor 141 is installed on pedestal 112. When the first twisting hydraulic cylinder 146 and the second twisting hydraulic cylinder 148 apply torque on the turnplate 144 together, the elastic bearing will bear a certain torque. And the rotation angle of turnplate 144 can be measured by the first laser displacement sensor 141, such that the rotation angle of elastic bearing can be confirmed. Meanwhile, the force applied by the first twisting hydraulic cylinder 146 and the second twisting hydraulic cylinder 148 can be respectively measured by the first displacement sensor 145 and second displacement sensor 149. The torsional stiffness characteristic of elastic bearing can be calculated by the force and the rotation angle.

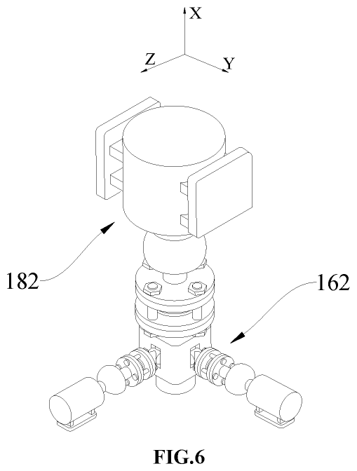

As illustrated in FIG. 1 and FIG. 6, FIG. 6 illustrates a structure diagram of a second testing means 160. The second testing means 160 comprises a bending testing unit 162 and a compression testing unit 182. The bending testing unit 162 connects with the second fixing platform 124 by the second spline shaft 125. The bending testing unit 162 can drive the second fixing platform 124 to move in a preprogrammed direction, so that the bending stiffness characteristics of elastic bearing can be measured. One side of the bending testing unit 162 away from the second fixing platform 124 connects with the compression testing unit 182.

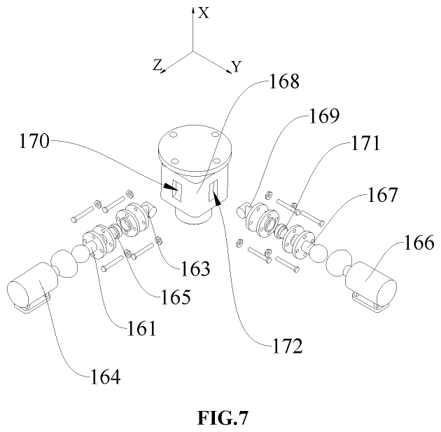

FIG. 7 illustrates a structure diagram of a bending testing unit 162. The bending testing unit 162 comprises a first bending hydraulic cylinder 164, a second bending hydraulic cylinder 166 and a mounting part 168. The mounting part 168 and the second fixing platform 124 are in demountable connection by the second spline shaft 125 in a transmission way, so that testers can choose different second fixing platform 124 according to different elastic bearing. In some embodiments, the second fixing platform 124 and the mounting part 168 could be in permanent connection by such as glue joint or welding. One side of the mounting part 168 away from the second fixing platform 124 connects with the compression testing unit 182 by a flange.

In this embodiment, the first bending hydraulic cylinder 164 can stretch out and draw back in the direction of Z-axis. The bending stiffness characteristics of elastic bearing in the direction of the Z-axis can be measured by the first bending hydraulic cylinder 164. The second bending hydraulic cylinder 166 can stretch out and draw back in the direction of Y-axis. The bending stiffness characteristics of elastic bearing in the direction of the Y-axis can be measured by the second bending hydraulic cylinder 166. The first bending hydraulic cylinder 164 and the second bending hydraulic cylinder 166 are at the same horizontal plane. The stretching directions of the first bending hydraulic cylinder 164 and the second bending hydraulic cylinder 166 are perpendicular to each other, and both of the stretching directions are both perpendicular to the rotation axle 114. The first bending hydraulic cylinder 164 and the second bending hydraulic cylinder 166 are both installed on the mounting part 168. The first bending hydraulic cylinder 164 and/or the second bending hydraulic cylinder 166 can drive the second fixing platform 124 to move in preset direction, such that the bending stiffness characteristics of elastic bearing in different direction can be measured.

The first bending hydraulic cylinder 164 and the second bending hydraulic cylinder 166 can simultaneously drive the second fixing platform 124 to move in Y-axis direction and Z-axis direction, such that the bending stiffness characteristics of elastic bearing in Y-axis direction and Z-axis direction can be tested at the same time. In some embodiments, the tester can choose one of the first bending hydraulic cylinder 164 and the second bending hydraulic cylinder 166 to test.

The first bending hydraulic cylinder 164 connects with the mounting part 168 by a first adapting piece (not marked in FIG. 7). The first adapting piece includes a first bend connecting rod 161 and a second connecting rod 163. The first bending hydraulic cylinder 164, the first bend connecting rod 161, the second connecting rod 163 and the mounting part 168 connect successively. The end of the piston of the first bending hydraulic cylinder 164 is equipped with a shaft bowl. One end of the first bend connecting rod 161 near the first bending hydraulic cylinder 164 is spherical, and the shaft bowl is hinged with the spherical portion. One end of the first bend connecting rod 161 away from the first bending hydraulic cylinder 164 connects with one end of the second connecting rod 163 away from the mounting part 168 by a pair of flanges. The end of the second connecting rod 163 near the mounting part 168 is equipped with a cup head pin, and the second connecting rod 163 connects with the mounting part 168 by the cup head pin. A first bending force transducer 165 is installed between the pair of flanges. The first bending force transducer 165 is used to measure the force applied by the first bending hydraulic cylinder 164 to the mounting part 168.

As illustrated in FIG. 1, in the direction of Z-axis, a second laser displacement sensor 173 is installed on the horizontal plane of the fixing cavity 123. The second laser displacement sensor 173 can be fixed with the help of external fixed supports, as long as the deformation in the direction of Z-axis of elastic bearing can be tested by the second laser displacement sensor 173.

When the first bending hydraulic cylinder 164 applies force to the mounting part 168, the mounting part 168 will drive the second fixing platform 124 to produce deformation in the direction of Z-axis, and then the elastic bearing will produce deformation in the direction of Z-axis. The second laser displacement sensor 173 can measure the deformation of elastic bearing, the first bending force transducer 165 can measure the force simultaneously, and then bending stiffness characteristics in the direction of Z-axis of elastic bearing can be calculated.

As illustrated in FIG. 7, the second bending hydraulic cylinder 166 connects with the mounting part 168 by a second adapting piece (not marked in FIG. 7). The second adapting piece comprises a third bend connecting rod 167 and a forth bend connecting rod 169. The second bending hydraulic cylinder 166, the third bend connecting rod 167, the forth bend connecting rod 169 and the mounting part 168 connect successively. The end of the piston of the second bending hydraulic cylinder 166 is equipped with a shaft bowl. One end of the third bend connecting rod 167 near the second bending hydraulic cylinder 166 is spherical, and the shaft bowl is hinged with the spherical portion. One end of the third bend connecting rod 167 away from the second bending hydraulic cylinder 166 connects with one end of the forth bend connecting rod 169 away from the mounting part 168 by a pair of flanges. The end of the forth bend connecting rod 169 near the mounting part 168 is equipped with a cup head pin, and the forth bend connecting rod 169 connects with the mounting part 168 by the cup head pin. A second bending force transducer 171 is installed between the pair of flanges. The second bending force transducer 171 is used to measure the force applied by the second bending hydraulic cylinder 166 to the mounting part 168.

As illustrated in FIG. 1, in the direction of Y-axis, a third laser displacement sensor 175 is installed on the horizontal plane of the fixing cavity 123. The third laser displacement sensor 175 can be fixed with the help of external fixed supports, as long as the deformation in the direction of Y-axis of elastic bearing can be tested by the third laser displacement sensor 175.

When the second bending hydraulic cylinder 166 applies force to the mounting part 168, the mounting part 168 will drive the second fixing platform 124 to produce deformation in the direction of Y-axis, and then the elastic bearing will produce deformation in the direction of Y-axis. The third laser displacement sensor 175 can measure the deformation of elastic bearing, the second bending force transducer 171 can measure the force simultaneously, and then bending stiffness characteristics in the direction of Y-axis of elastic bearing can be calculated.

The mounting part 168 is provided with a first installation groove 170 and a second installation groove 172. The cup head pin on the second connecting rod 163 is located in the first installation groove 170. The cup head pin on the forth bend connecting rod 169 is located in the second installation groove 172. In the direction of the axes of rotation axle 114, the length of the first installation groove 170 is longer than the length of the second connecting rod 163, the length of second installation groove 172 is longer than the forth bend connecting rod 169, such that the second connecting rod 163, the forth bend connecting rod 169 and mounting part 168 will not produce mutual interference during the testing. When the mounting part 168 start to deform in the direction of Z-axis, the second connecting rod 163 will generate relative movement in the first installation groove 170, the forth bend connecting rod 169 will generate relative movement in the second installation groove 172, the three kinds of movements above will not produce mutual interference.

The first installation groove 170 can also achieves the following purposes:

The first bending hydraulic cylinder 164 can control the elastic bearing to bend in the positive direction of Z-axis or the negative direction of Z-axis, thus the bending stiffness characteristics of elastic bearing in the positive direction of Z-axis or the negative direction of Z-axis can be measured.

The second installation groove 172 can also achieves the following purposes:

The second bending hydraulic cylinder 166 can control the elastic bearing to bend in the positive direction of Y-axis or the negative direction of Y-axis, thus the bending stiffness characteristics of elastic bearing in the positive direction of Y-axis or the negative direction of Y-axis can be measured.

As illustrated in FIG. 3, the compression testing unit 182 comprises a compressing hydraulic cylinder 184, one side of the mounting part 168 away from the second fixing platform 124 is connected with the compressing hydraulic cylinder 184 through a compression connecting rod 183. The compressing hydraulic cylinder 184 can stretch out and draw back in the direction of X-axis. The compression stiffness characteristics of elastic bearing in the direction of the X-axis can be measured by the compressing hydraulic cylinder 184. The end of the piston of the compressing hydraulic cylinder 184 is equipped with a shaft bowl. One end of the compression connecting rod 183 near the compressing hydraulic cylinder 184 is spherical. And the shaft bowl is hinged with the spherical portion, such that the compression connecting rod 183 will not produce bending deformation during the testing.

One end of the compression connecting rod 183 away from the compressing hydraulic cylinder 184 connects with one side of the mounting part 168 away from the second fixing platform 124 by a pair of flanges. A pressure sensor 185 is installed between the flanges. The pressure sensor 185 is used to test the pressure applied to the elastic bearing by the compressing hydraulic cylinder 184.

As illustrated in FIG. 3, the center line of compressing hydraulic cylinder 184, the center line of compression connecting rod 183, the center line of mounting part 168, the center line of second fixing platform 124, the center line of first fixing platform 122 and the axis of rotation axle 114 are all coaxial with the X-axis, such that the errors in the testing process of compression stiffness characteristics of elastic bearing can be reduced and the accuracy of test can be improved.

As illustrated in FIG. 1, in this embodiment, a forth laser displacement sensor 187 is provided in a direction, approach to the forward part of Y-axis, with 45 degree with respect to the forward part of Z-axis. In some embodiments, the forth laser displacement sensor 187 may be provided in other positions, as long as it can measure the compression deformation of elastic bearing. The forth laser displacement sensor 187 can be fixed with the help of external fixed supports, as long as the compression deformation in the direction of X-axis of elastic bearing can be tested by the forth laser displacement sensor 187.

The forth laser displacement sensor 187 can measure the compression deformation of elastic bearing under the load applied by compressing hydraulic cylinder 184, combined with the measurement of pressure sensor 185, the compression stiffness characteristics of elastic bearing can be calculated.

The mechanical performance testing device 100 works as follows

Testing of compression stiffness characteristics of an elastic bearing in the direction of X-axis

The compressing hydraulic cylinder 184 applies force to the elastic bearing, and the rest of the hydraulic cylinders are closed, the pressure sensor 185 can test the pressure applied to the elastic bearing by the compressing hydraulic cylinder 184. At the same time, the forth laser displacement sensor 187 can measure the compression deformation in the direction of X-axis of elastic bearing. The compression stiffness of elastic bearing can be calculated by the pressure and the compression deformation.

Testing of bending stiffness characteristics of an elastic bearing in the direction of Z-axis

The first bending hydraulic cylinder 164 applies force to the elastic bearing, and the rest of the hydraulic cylinders are closed, the first bending force transducer 165 can test the bending force and bending moment applied to the elastic bearing by the first bending hydraulic cylinder 164. At the same time, the second laser displacement sensor 173 can measure the angle of bending in the direction of Z-axis of elastic bearing. The bending stiffness of elastic bearing can be calculated by the bending moment and the angle of bending. It is should be noted that the bending stiffness characteristics in the positive and negative direction of Z-axis of elastic bearing can be measured respectively, by keeping the first bending hydraulic cylinder 164 in different working states.

Testing of bending stiffness characteristics of an elastic bearing in the direction of Y-axis:

The second bending hydraulic cylinder 166 applies force to the elastic bearing, the second bending force transducer 171 can test the bending force and bending moment applied to the elastic bearing by the second bending hydraulic cylinder 166. At the same time, the third laser displacement sensor 175 can measure the angle of bending in the direction of Y-axis of elastic bearing. The bending stiffness of elastic bearing can be calculated by the bending moment and the angle of bending. It is should be noted that the bending stiffness characteristics in the positive and negative direction of Y-axis of elastic bearing can be measured respectively, by keeping the second bending hydraulic cylinder 166 in different working states.

Testing of torsional stiffness characteristics of an elastic bearing around the X-axis:

The first locking hydraulic cylinder 128, the second locking hydraulic cylinder 130, the first twisting hydraulic cylinder 146 and the second twisting hydraulic cylinder 148 cooperate to measure the torsional stiffness characteristic around the X-axis of the elastic bearing, and the rest of the hydraulic cylinders are closed. The second fixing platform 124 is locked by the first locking hydraulic cylinder 128 and the second locking hydraulic cylinder 130, to prevent the rotation of the top of elastic bearing. The first twisting hydraulic cylinder 146 and the second twisting hydraulic cylinder 148 apply torque on the turnplate 144 together, the rotation of turnplate 144 will make the rotation axle 114 rotate, and the rotation axle 114 will make the first fixing platform 122 rotate, and eventually make the bottom of elastic bearing produces rotation. The torque applied on the elastic bearing can be calculated by the radius of turnplate 144, the test results of first displacement sensor 145 and the test results of second displacement sensor 149. The torsional stiffness around the X-axis can be calculated by the torque and the test results of first laser displacement sensor 141. It should be noted that the torsional stiffness of the elastic bearing in both clockwise and counterclockwise directions around the X-axis can be calculated respectively by adjusting the working conditions of the first twisting hydraulic cylinder 146 and the second twisting hydraulic cylinder 148.

When the mechanical performance testing device 100 is used to measure the multidimensional stiffness characteristics of elastic bearing, the four testing methods mentioned above can be carried out simultaneously, separately or in any combination.

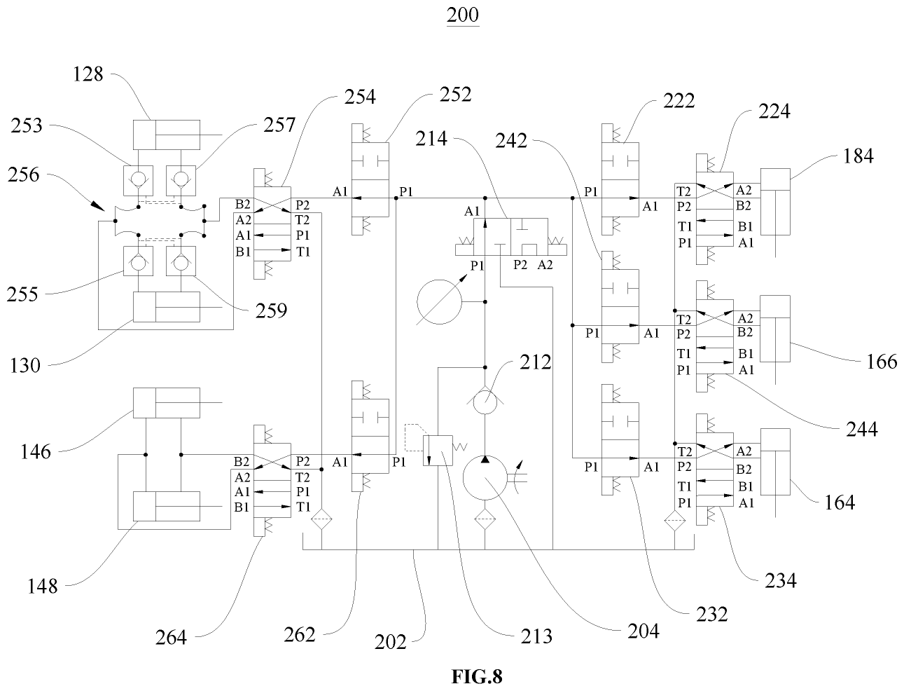

Please refer to FIG. 8, FIG. 8 illustrates a control schematic diagram of a hydraulic control system 200, when the torsional stiffness characteristics of elastic bearings around the X-axis, the bending stiffness characteristics in the Y-axis direction, the stiffness characteristics in the Z-axis direction and the compression stiffness characteristics in the X axis direction are tested at the same time. The hydraulic control system 200 can be used in the mechanical performance testing device 100. When the hydraulic control system 200 control the mechanical performance testing device 100 to measure the multidimensional stiffness characteristics of elastic bearing, the test efficiency of the mechanical performance testing device 100 will be improved, the working intensity of testers will be reduced, the safety during the testing will be improved, the accuracy of the test results will be improved.

The hydraulic control system 200 comprises fuel tank 202, oil pump 204 and control valves (not marked in figures). And the fuel tank 202, the oil pump 204 and the control valves connect successively. The fuel tank 202 and oil pump 204 cooperate to provide oil. The control valves are used to control the extend-retract of the compressing hydraulic cylinder 184. The control valves are used to control the extend-retract of the first bending hydraulic cylinder 164. The control valves are used to control the extend-retract of the second bending hydraulic cylinder 166. The control valves are used to control the extend-retract of the first twisting hydraulic cylinder 146 and the second twisting hydraulic cylinder 148. The control valves are used to control the extend-retract of the first locking hydraulic cylinder 128 and the second locking hydraulic cylinder 130.

The control valves comprise a check valve 212, a 2-position 3-way magnetic exchange valve 214, a first 2-position 2-way magnetic exchange valve 222 and a first 2-position 4-way magnetic exchange valve 224. The fuel tank 202, the oil pump 204 and the check valve 212 connect successively. The outlet of the check valve 212 is connected to a first entrance P1 of the 2-position 3-way magnetic exchange valve 214. A first outlet A1 of the 2-position 3-way magnetic exchange valve 214 is connected to the entrance P1 of the first 2-position 2-way magnetic exchange valve 222. The outlet A1 of the first 2-position 2-way magnetic exchange valve 222 is connected to a second entrance P2 of the first 2-position 4-way magnetic exchange valve 224. A second outlet A2 of the first 2-position 4-way magnetic exchange valve 224 is connected to the rod-less cavity (not marked in FIG. 8) of compressing hydraulic cylinder 184. The rod cavity (not marked in FIG. 8) of compressing hydraulic cylinder 184 is connected to an entrance B2 of the first 2-position 4-way magnetic exchange valve 224. An oil return port T2 of the first 2-position 4-way magnetic exchange valve 224 is connected to the fuel tank 202.

In this embodiment, an overflow valve 213 is installed at the outlet of check valve 212. The overflow valve 213 is used to protect the hydraulic control system 200 from overload. The overflow valve 213 is used to protect the hydraulic control system 200 from potential safety hazard due to the pressure of hydraulic control system 200 is too large.

The control valves further comprise a second 2-position 2-way magnetic exchange valve 232 and a second 2-position 4-way magnetic exchange valve 234. The first outlet A1 of the 2-position 3-way magnetic exchange valve 214 is connected to the entrance P1 of second 2-position 2-way magnetic exchange valve 232. The outlet A1 of second 2-position 2-way magnetic exchange valve 232 is connected to a second entrance P2 of the second 2-position 4-way magnetic exchange valve 234. A second outlet A2 of the second 2-position 4-way magnetic exchange valve 234 is connected to the rod-less cavity (not marked in FIG. 8) of the first bending hydraulic cylinder 164. The rod cavity (not marked in FIG. 8) of first bending hydraulic cylinder 164 is connected to an entrance B2 of the second 2-position 4-way magnetic exchange valve 234. An oil return port T2 of the second 2-position 4-way magnetic exchange valve 234 is connected to the fuel tank 202.

The control valves further comprise a third 2-position 2-way magnetic exchange valve 242 and a third 2-position 4-way magnetic exchange valve 244. The first outlet A1 of the 2-position 3-way magnetic exchange valve 214 is connected to the entrance P1 of third 2-position 2-way magnetic exchange valve 242. The outlet A1 of third 2-position 2-way magnetic exchange valve 242 is connected to a second entrance P2 of the third 2-position 4-way magnetic exchange valve 244. A second outlet A2 of the third 2-position 4-way magnetic exchange valve 244 is connected to the rod-less cavity (not marked in FIG. 8) of the second bending hydraulic cylinder 166. The rod cavity (not marked in FIG. 8) of second bending hydraulic cylinder 166 is connected to an entrance B2 of the third 2-position 4-way magnetic exchange valve 244. An oil return port T2 of the third 2-position 4-way magnetic exchange valve 244 is connected to the fuel tank 202.

The control valves further comprise a fourth 2-position 2-way magnetic exchange valve 252, a fourth 2-position 4-way magnetic exchange valve 254 and hydraulic control one-way valve groups 256. The first outlet A1 of the 2-position 3-way magnetic exchange valve 214 is connected to the entrance P1 of fourth 2-position 2-way magnetic exchange valve 252. The outlet A1 of fourth 2-position 2-way magnetic exchange valve 252 is connected to a second entrance P2 of the fourth 2-position 4-way magnetic exchange valve 254. A second outlet A2 of the fourth 2-position 4-way magnetic exchange valve 254 is connected to the rod-less cavity of the first locking hydraulic cylinder 128 and the second locking hydraulic cylinder 130 respectively through the hydraulic control one-way valve groups 256. The rod cavity of the first locking hydraulic cylinder 128 and the second locking hydraulic cylinder 130 are both connected to an entrance B2 of the fourth 2-position 4-way magnetic exchange valve 254. An oil return port T2 of the fourth 2-position 4-way magnetic exchange valve 254 is connected to the fuel tank 202.

The hydraulic control one-way valve groups 256 include a first hydraulic control one-way valve 253, a second hydraulic control one-way valve 255, a third hydraulic control one-way valve 257 and a fourth hydraulic control one-way valve 259. The outlet of the first hydraulic control one-way valve 253 and the outlet of second hydraulic control one-way valve 255 are in parallel installation, and both of them are connected to the second outlet A2 of the fourth 2-position 4-way magnetic exchange valve 254. The entrance of the first hydraulic control one-way valve 253 is connected to the rod-less cavity of the first locking hydraulic cylinder 128. The entrance of the second hydraulic control one-way valve 255 is connected to the rod-less cavity of the second locking hydraulic cylinder 130. The rod-less cavity of the first locking hydraulic cylinder 128 and the rod-less cavity of second locking hydraulic cylinder 130 are in parallel installation. The rod cavity of the first locking hydraulic cylinder 128 is connected to the entrance of third hydraulic control one-way valve 257. The rod cavity of the second locking hydraulic cylinder 130 is connected to the entrance of fourth hydraulic control one-way valve 259. The outlet of third hydraulic control one-way valve 257 and the outlet of fourth hydraulic control one-way valve 259 are in parallel installation, and both of them are connected to the entrance B2 of fourth 2-position 4-way magnetic exchange valve 254. The rod cavity of the first locking hydraulic cylinder 128 and the rod cavity of second locking hydraulic cylinder 130 are in parallel installation.

The control valves further comprise a fifth 2-position 2-way magnetic exchange valve 262 and a fifth 2-position 4-way magnetic exchange valve 264. The first outlet A1 of the 2-position 3-way magnetic exchange valve 214 is connected to the entrance P1 of fifth 2-position 2-way magnetic exchange valve 262. The outlet A1 of fifth 2-position 2-way magnetic exchange valve 262 is connected to a second entrance P2 of the fifth 2-position 4-way magnetic exchange valve 264. A second outlet A2 of the fifth 2-position 4-way magnetic exchange valve 264 is connected to the rod-less cavity (not marked in the figures) of the first twisting hydraulic cylinder 146 and the rod-less cavity (not marked in the figures) of the second twisting hydraulic cylinder 148 respectively. The rod cavity (not marked in the figures) of the first twisting hydraulic cylinder 146 and rod cavity (not marked in the figures) of the second twisting hydraulic cylinder 148 are both connected to an entrance B2 of the fifth 2-position 4-way magnetic exchange valve 264. An oil return port T2 of the fifth 2-position 4-way magnetic exchange valve 264 is connected to the fuel tank 202.

In this embodiment, the oil return port T2 of the first 2-position 4-way magnetic exchange valve 224, the oil return port T2 of the second 2-position 4-way magnetic exchange valve 234 and the oil return port T2 of the third 2-position 4-way magnetic exchange valve 244 are in parallel installation, and all of them are connected with a filtrator. The filtrator is connected with the fuel tank 202.

The hydraulic control system 200 works as follows

Table 1 illustrates different working positions of all the magnetic exchange valves in different tests. It is should be noted that all the 2-position 4-way magnetic exchange valves in FIGS. 8-17, for example the first 2-position 4-way magnetic exchange valve 224, “1” represents P1, A1, B1 and T1 connect successively, “2” represents P2, A2, B2 and T2 connect successively. It is should be noted that all the 2-position 2-way magnetic exchange valves in FIGS. 8-17, for example the first 2-position 2-way magnetic exchange valve 222, have two states of “open” and “closed”. It is should be noted that all the 2-position 3-way magnetic exchange valves 214 in FIGS. 8-17, have two states of “open” and “closed”.

TABLE 1
different working positions of all the magnetic exchange valves in different tests.

| | test mode | | | | | |
|---|---|---|---|---|---|---|
| | | | | torsional | | |
| | compression | bending | bending | stiffness | | |
| | stiffness test | stiffness | stiffness | test | compression, | no |
| | in the | test in the | test in the | around the | bending and | stiffness |
| | direction | direction | direction | direction | torsional | tests are |
| number | of X-axis | of Y-axis | of Z-axis | of X-axis | stiffness test | performed |
| 214 | open | open | open | open | open | closed |
| 222 | open | closed | closed | closed | open | Open or |
| | | | | | | closed |
| 224 | 2 | 1 or 2 | 1 or 2 | 1 or 2 | 2 | 1 or 2 |
| 232 | closed | closed | open | closed | open | Open or |
| | | | | | | closed |
| 234 | 1 or 2 | 1 or 2 | 2 | 1 or 2 | 2 | 1 or 2 |
| 242 | closed | open | closed | closed | open | open or |
| | | | | | | closed |
| 244 | 1 or 2 | 2 | 1 or 2 | 1 or 2 | 2 | 1 or 2 |
| 252 | closed | closed | closed | open | open | open or |
| | | | | | | closed |
| 254 | 1 or 2 | 1 or 2 | 1 or 2 | 2 | 2 | 1 or 2 |
| 262 | closed | closed | closed | open | open | open or |
| | | | | | | closed |
| 264 | 1 or 2 | 1 or 2 | 1 or 2 | 2 | 2 | 1 or 2 |

The first working condition: testing for compression stiffness characteristics of an elastic bearing in the direction of the X-axis.

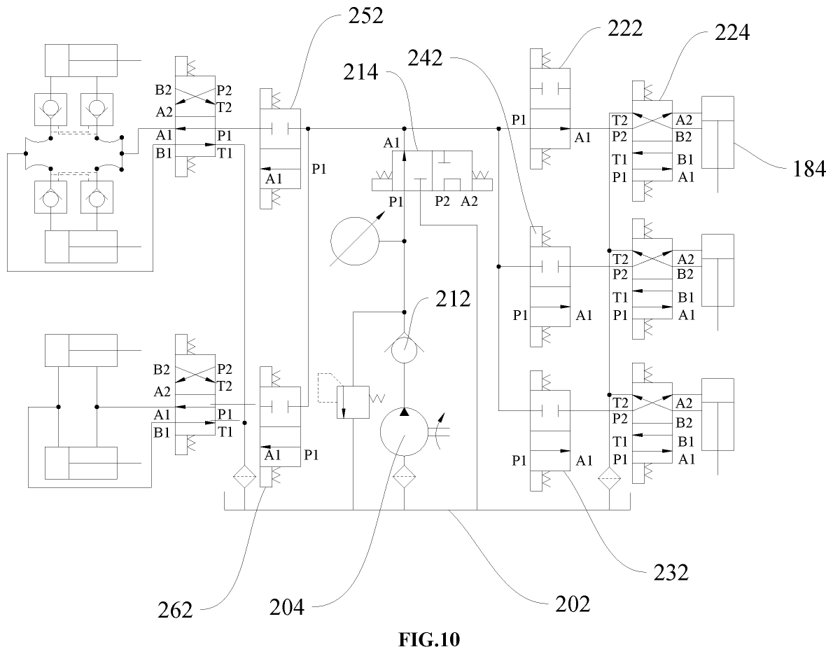

As illustrated in FIG. 10 and Table 1, FIG. 10 illustrates a control schematic diagram of a hydraulic control system 200 which has began to test the compression stiffness characteristics of an elastic bearing in the direction of the X-axis. When the testers begin to measure the compression stiffness characteristics of an elastic bearing in the direction of the X-axis, the 2-position 3-way magnetic exchange valve 214 is in the position of “open”, the first 2-position 2-way magnetic exchange valve 222 is in the position of “open”, the first 2-position 4-way magnetic exchange valve 224 is in the position of “2”. The second 2-position 2-way magnetic exchange valve 232, the third 2-position 2-way magnetic exchange valve 242, the fourth 2-position 2-way magnetic exchange valve 252 and the fifth 2-position 2-way magnetic exchange valve 262 are all in the position of “closed”, the other magnetic exchange valves can be in any working position. The working positions of all the magnetic exchange valves are shown in Table 1. Under the test condition above, the flow routes of hydraulic oil are as follows:

The hydraulic oil is pumped by oil pump 204, hydraulic oil flows successively through the check valve 212, the first outlet A1 of 2-position 3-way magnetic exchange valve 214, the first outlet A1 of the first 2-position 2-way magnetic exchange valve 222, the second outlet A2 of the first 2-position 4-way magnetic exchange valve 224 and the rod-less cavity of compressing hydraulic cylinder 184. The hydraulic oil in the rod cavity of compressing hydraulic cylinder 184 flows successively through the oil return port T2 of the first 2-position 4-way magnetic exchange valve 224, the filtrator and the fuel tank 202. And then, applying pressure on the elastic bearing in the direction of X-axis is completed, and the other hydraulic cylinders don't work in this test process. The compression stiffness characteristics of elastic bearing can be calculated according to the pressure on the elastic bearing and the compression deformation of elastic bearing in the direction of X-axis.

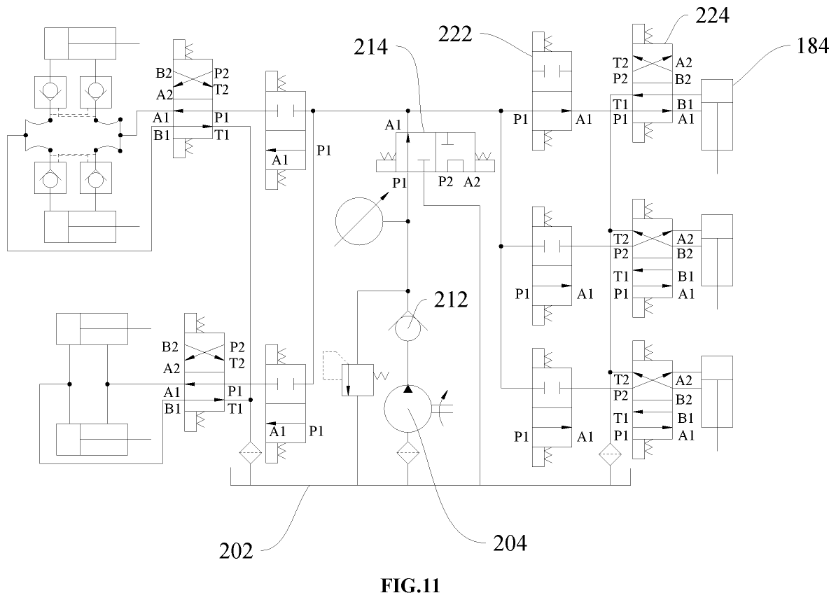

FIG. 11 illustrates the control schematic diagram of a hydraulic control system 200 which has began to withdraw the force on the elastic bearing in the direction of the X-axis. When the hydraulic control system 200 has began to withdraw the force on the elastic bearing in the direction of the X-axis, the position of first 2-position 4-way magnetic exchange valve 224 has been switched from “2” to “1”, the positions of other magnetic exchange valves are invariant. Under the condition above, the flow routes of hydraulic oil are as follows:

The hydraulic oil is pumped by oil pump 204, hydraulic oil flows successively through the check valve 212, the first outlet A1 of 2-position 3-way magnetic exchange valve 214, the first outlet A1 of the first 2-position 2-way magnetic exchange valve 222, the first outlet A1 of the first 2-position 4-way magnetic exchange valve 224 and the rod cavity of compressing hydraulic cylinder 184. The hydraulic oil in the rod-less cavity of compressing hydraulic cylinder 184 flows successively through the oil return port T1 of the first 2-position 4-way magnetic exchange valve 224, the filtrator and the fuel tank 202. Finally, the force on the elastic bearing in the direction of X-axis can be removed.

The second working condition: testing for bending stiffness characteristics of an elastic bearing in the direction of the Y-axis.

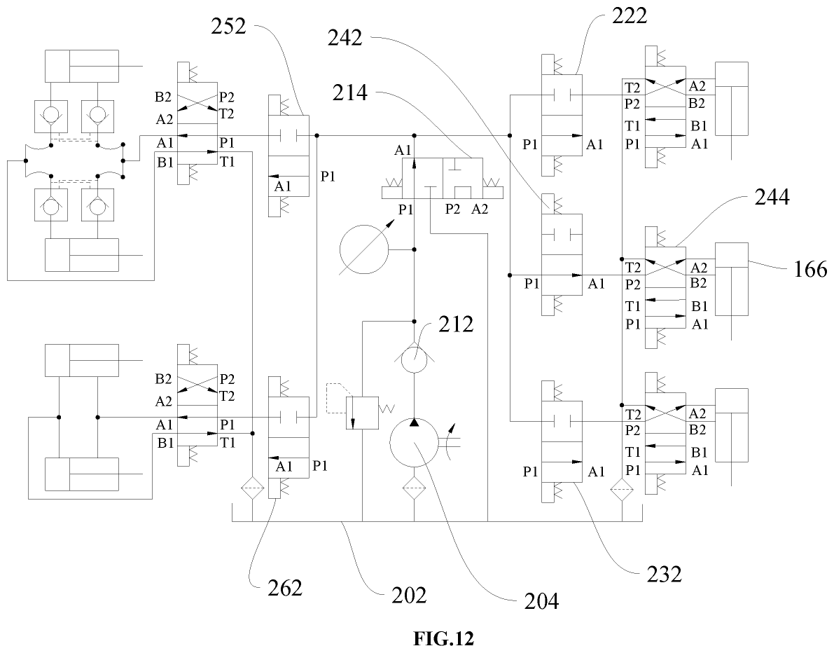

As illustrated in FIG. 12 and Table 1, FIG. 12 illustrates a control schematic diagram of a hydraulic control system 200 which has began to test the bending stiffness characteristics of an elastic bearing in the direction of the Y-axis. When the testers begin to measure the bending stiffness characteristics of an elastic bearing in the direction of the Y-axis, the 2-position 3-way magnetic exchange valve 214 is in the position of “open”, the third 2-position 2-way magnetic exchange valve 242 is in the position of “open”, the first 2-position 4-way magnetic exchange valve 224 is in the position of “2”. The first 2-position 2-way magnetic exchange valve 222, the second 2-position 2-way magnetic exchange valve 232, the fourth 2-position 2-way magnetic exchange valve 252 and the fifth 2-position 2-way magnetic exchange valve 262 are all in the position of “closed”, the other magnetic exchange valves can be in any working position. The working positions of all the magnetic exchange valves are shown in Table 1. Under the test condition above, the flow routes of hydraulic oil are as follows:

The hydraulic oil is pumped by oil pump 204, hydraulic oil flows successively through the check valve 212, the first outlet A1 of 2-position 3-way magnetic exchange valve 214, the first outlet A1 of the third 2-position 2-way magnetic exchange valve 242, the second outlet A2 of the third 2-position 4-way magnetic exchange valve 244 and the rod-less cavity of second bending hydraulic cylinder 166. The hydraulic oil in the rod cavity of second bending hydraulic cylinder 166 flows successively through the oil return port T2 of the third 2-position 4-way magnetic exchange valve 244, the filtrator and the fuel tank 202. And then, applying pressure on the elastic bearing in the direction of Y-axis is completed, and the other hydraulic cylinders don't work in this test process. The bending stiffness characteristics of elastic bearing can be calculated according to the bending angle of elastic bearing in the direction of X-axis and the magnitude of bending force.

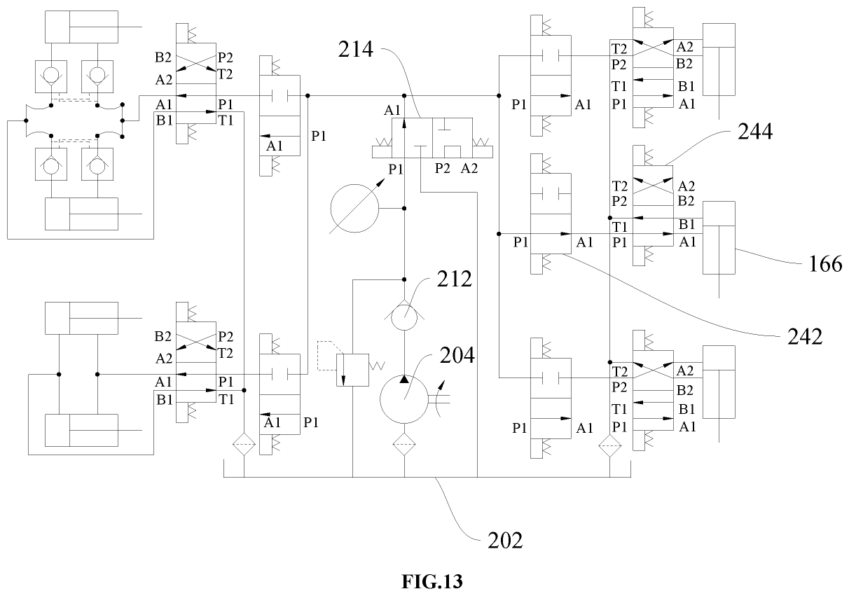

FIG. 13 illustrates the control schematic diagram of a hydraulic control system 200 which has began to withdraw the force on the elastic bearing in the direction of the Y-axis. When the hydraulic control system 200 has began to withdraw the force on the elastic bearing in the direction of the Y-axis, the position of the third 2-position 4-way magnetic exchange valve 244 has been switched from “2” to “1”, the positions of other magnetic exchange valves are invariant. Under the condition above, the flow routes of hydraulic oil are as follows:

The hydraulic oil is pumped by oil pump 204, hydraulic oil flows successively through the check valve 212, the first outlet A1 of 2-position 3-way magnetic exchange valve 214, the first outlet A1 of the third 2-position 2-way magnetic exchange valve 242, the first outlet A1 of the third 2-position 4-way magnetic exchange valve 244 and the rod cavity of second bending hydraulic cylinder 166. The hydraulic oil in the rod-less cavity of second bending hydraulic cylinder 166 flows successively through the oil return port T1 of the third 2-position 4-way magnetic exchange valve 244, the filtrator and the fuel tank 202. Finally, the force on the elastic bearing in the direction of Y-axis can be removed.

The third working condition: testing for bending stiffness characteristics of an elastic bearing in the direction of the Z-axis.

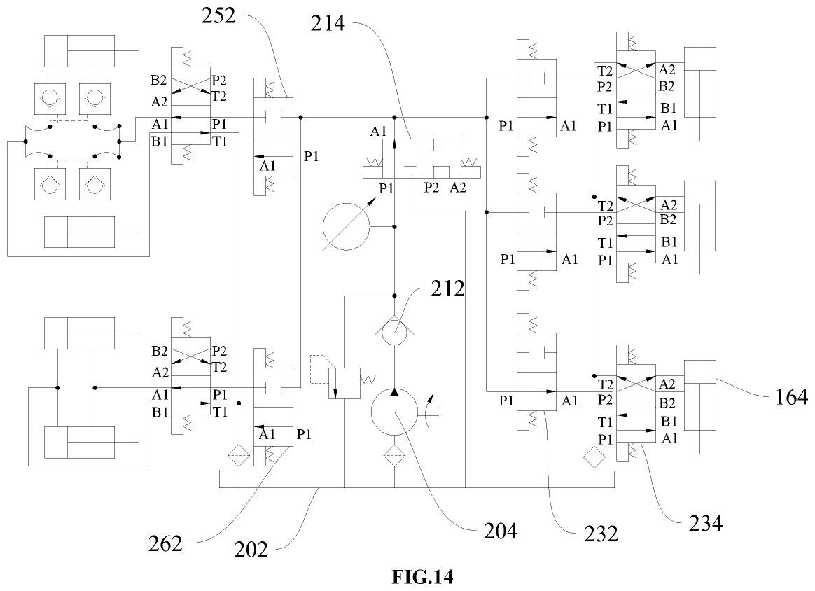

As illustrated in FIG. 14 and Table 1, FIG. 14 illustrates a control schematic diagram of a hydraulic control system 200 which has began to test the bending stiffness characteristics of an elastic bearing in the direction of the Z-axis. When the testers begin to measure the bending stiffness characteristics of an elastic bearing in the direction of the Z-axis, the 2-position 3-way magnetic exchange valve 214 is in the position of “open”, the second 2-position 2-way magnetic exchange valve 232 is in the position of “open”, the second 2-position 4-way magnetic exchange valve 234 is in the position of “2”. The first 2-position 2-way magnetic exchange valve 222, the third 2-position 2-way magnetic exchange valve 242, the fourth 2-position 2-way magnetic exchange valve 252 and the fifth 2-position 2-way magnetic exchange valve 262 are all in the position of “closed”, the other magnetic exchange valves can be in any working position. The working positions of all the magnetic exchange valves are shown in Table 1. Under the test condition above, the flow routes of hydraulic oil are as follows:

The hydraulic oil is pumped by oil pump 204, hydraulic oil flows successively through the check valve 212, the first outlet A1 of 2-position 3-way magnetic exchange valve 214, the first outlet A1 of the second 2-position 2-way magnetic exchange valve 232, the second outlet A2 of the second 2-position 4-way magnetic exchange valve 234 and the rod-less cavity of first bending hydraulic cylinder 164. The hydraulic oil in the rod cavity of first bending hydraulic cylinder 164 flows successively through the oil return port T2 of the second 2-position 4-way magnetic exchange valve 234, the filtrator and the fuel tank 202. And then, applying pressure on the elastic bearing in the direction of Z-axis is completed, and the other hydraulic cylinders don't work in this test process. The bending stiffness characteristics of elastic bearing can be calculated according to the bending angle of elastic bearing in the direction of Z-axis and the magnitude of bending force.

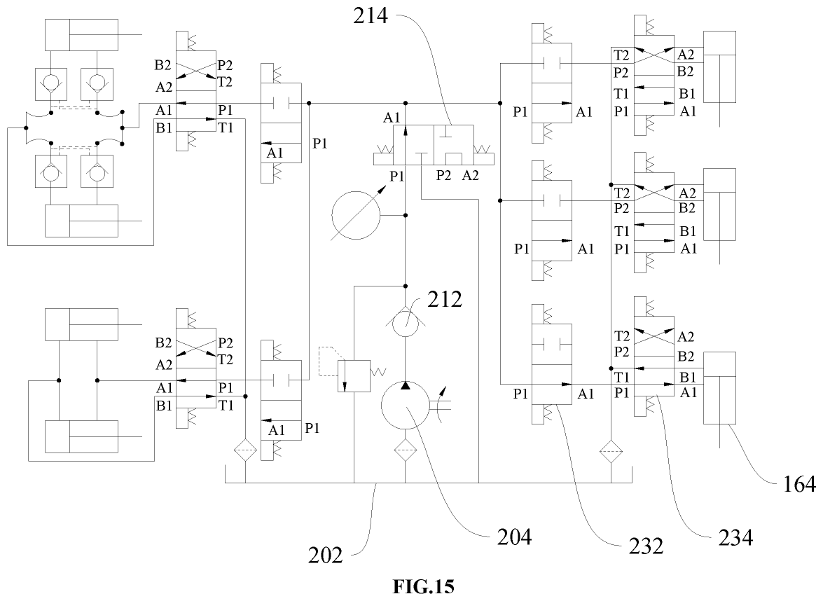

FIG. 15 illustrates the control schematic diagram of hydraulic control system 200 when unloading after testing the bending stiffness characteristic of elastic bearing in the direction of the Z-axis. When the hydraulic control system 200 has began to withdraw the force on the elastic bearing in the direction of the Z-axis, the position of second 2-position 4-way magnetic exchange valve 234 has been switched from “2” to “1”, the positions of other magnetic exchange valves are invariant. Under the condition above, the flow routes of hydraulic oil are as follows:

The hydraulic oil is pumped by oil pump 204, hydraulic oil flows successively through the check valve 212, the first outlet A1 of 2-position 3-way magnetic exchange valve 214, the first outlet A1 of the second 2-position 2-way magnetic exchange valve 232, the first outlet A1 of the second 2-position 4-way magnetic exchange valve 234 and the rod cavity of first bending hydraulic cylinder 164. The hydraulic oil in the rod-less cavity of first bending hydraulic cylinder 164 flows successively through the oil return port T1 of the second 2-position 4-way magnetic exchange valve 234, the filtrator and the fuel tank 202. Finally, the force on the elastic bearing in the direction of Z-axis can be removed.

The fourth working condition: testing for torsional stiffness characteristics of an elastic bearing around the X-axis.

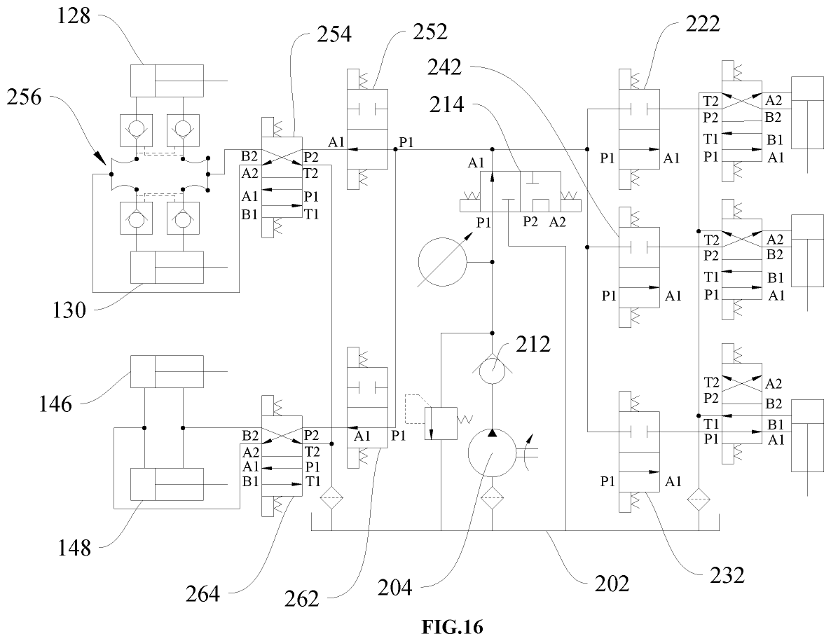

As illustrated in FIG. 16 and Table 1, FIG. 16 illustrates a control schematic diagram of a hydraulic control system 200 which has began to test the torsional stiffness characteristics of an elastic bearing around the X-axis. When the testers begin to measure the torsional stiffness characteristics of an elastic bearing around the X-axis, the 2-position 3-way magnetic exchange valve 214 is in the position of “open”, the fourth 2-position 2-way magnetic exchange valve 252 is in the position of “open”, the fourth 2-position 4-way magnetic exchange valve 254 is in the position of “2”. The first 2-position 2-way magnetic exchange valve 222, the second 2-position 2-way magnetic exchange valve 232, the third 2-position 2-way magnetic exchange valve 242 and the fifth 2-position 2-way magnetic exchange valve 262 are all in the position of “closed”, the other magnetic exchange valves can be in any working position. Thus the second fixing platform 124 can be fixed by the locking means 126. Two seconds later, the fifth 2-position 2-way magnetic exchange valve 262 will switch to the position of “open”, the fifth 2-position 4-way magnetic exchange valve 264 will switch to the position of “2”, to make the torsional testing unit 142 apply torsional force on the elastic bearing. The other magnetic exchange valves can be in any working position. The working positions of all the magnetic exchange valves are shown in Table 1. Under the test condition above, the hydraulic control system 200 has two working routes.

The first working route:

The hydraulic oil is pumped by oil pump 204, hydraulic oil flows successively through the check valve 212, the first outlet A1 of 2-position 3-way magnetic exchange valve 214, the first outlet A1 of fourth 2-position 2-way magnetic exchange valve 252, the second outlet A2 of fourth 2-position 4-way magnetic exchange valve 254 and the hydraulic control one-way valve groups 256. Then the hydraulic oil in the hydraulic control one-way valve groups 256 will enter the rod-less cavity of first locking hydraulic cylinder 128 and the rod-less cavity of second locking hydraulic cylinder 130 respectively. The hydraulic oil in the rod cavity of first locking hydraulic cylinder 128 and the rod cavity of second locking hydraulic cylinder 130 flow successively through the hydraulic control one-way valve groups 256, the oil return port T2 of fourth 2-position 4-way magnetic exchange valve 254, the filtrator and the fuel tank 202. When complete the clamping on the top of the elastic bearing, and then make it fixed and unable to rotate.

The second working route:

The hydraulic oil is pumped by oil pump 204, hydraulic oil flows successively through the check valve 212, the first outlet A1 of 2-position 3-way magnetic exchange valve 214, the first outlet A1 of fifth 2-position 2-way magnetic exchange valve 262, the second outlet A2 of fifth 2-position 4-way magnetic exchange valve 264, then simultaneously flow into the rod-less cavity of first twisting hydraulic cylinder 146 and the rod-less cavity of second twisting hydraulic cylinder 148. The hydraulic oil in the rod cavity of first twisting hydraulic cylinder 146 and the rod cavity of second twisting hydraulic cylinder 148 flow successively through the oil return port T2 of fifth 2-position 4-way magnetic exchange valve 264, the filtrator and the fuel tank 202. Finally the torque around the X-axis has been applied on the elastic bearing. The torsional stiffness characteristics of elastic bearing can be calculated according to the torsional force on the elastic bearing and the torsional angle of elastic bearing around the X-axis under the torsional force.

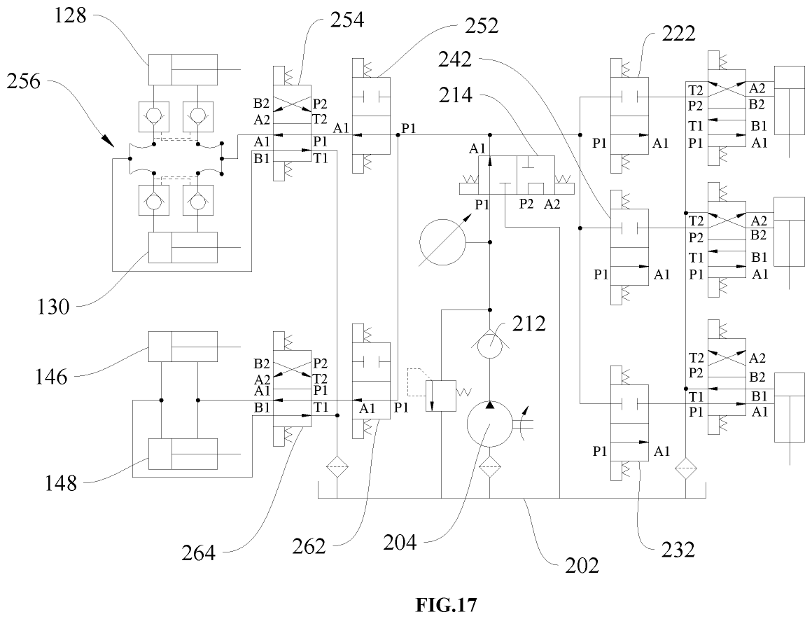

FIG. 17 illustrates the control schematic diagram of a hydraulic control system 200 which has began to withdraw the force on the elastic bearing around the X-axis. When the hydraulic control system 200 has began to withdraw the force on the elastic bearing around the X-axis, the position of fifth 2-position 4-way magnetic exchange valve 264 has been switched from “2” to “1”, two seconds later, the position of fourth 2-position 4-way magnetic exchange valve 254 has been switched from “2” to “1”, the positions of other magnetic exchange valves are invariant. Under the condition above, the hydraulic control system 200 has two unloading routes.

The first unloading route:

The hydraulic oil is pumped by oil pump 204, hydraulic oil flows successively through the check valve 212, the first outlet A1 of 2-position 3-way magnetic exchange valve 214, the first outlet A1 of the fifth 2-position 2-way magnetic exchange valve 262, the first outlet A1 of the fifth 2-position 4-way magnetic exchange valve 264, then simultaneously flow into the rod cavity of first twisting hydraulic cylinder 146 and the rod cavity of second twisting hydraulic cylinder 148. The hydraulic oil in the rod-less cavity of first twisting hydraulic cylinder 146 and the rod-less cavity of second twisting hydraulic cylinder 148 flow successively through the oil return port T1 of fifth 2-position 4-way magnetic exchange valve 264, the filtrator and the fuel tank 202. Finally, the force on the elastic bearing around the Z-axis can be removed.

The second unloading route:

The hydraulic oil is pumped by oil pump 204, hydraulic oil flows successively through the check valve 212, the first outlet A1 of 2-position 3-way magnetic exchange valve 214, the first outlet A1 of the fourth 2-position 2-way magnetic exchange valve 252, the first outlet A1 of the fourth 2-position 4-way magnetic exchange valve 254, the hydraulic control one-way valve groups 256, then simultaneously flow into the rod cavity of first locking hydraulic cylinder 128 and the rod cavity of second locking hydraulic cylinder 130. The hydraulic oil in the rod-less cavity of first locking hydraulic cylinder 128 and the rod-less cavity of second locking hydraulic cylinder 130, flow successively through the hydraulic control one-way valve groups 256, the oil return port T1 of fourth 2-position 4-way magnetic exchange valve 254, the filtrator and the fuel tank 202. Finally, the fixed force on the second fixing platform 124 can be removed.

The fifth working condition: testing simultaneously for torsional stiffness characteristics of an elastic bearing around the X-axis, bending stiffness characteristics in the direction of the Y-axis, bending stiffness characteristics in the direction of the Z-axis and compression stiffness characteristics in the direction of the X-axis.

As illustrated in FIG. 8 and Table 1, the 2-position 3-way magnetic exchange valve 214 is in the position of “open”, the first 2-position 2-way magnetic exchange valve 222, the second 2-position 2-way magnetic exchange valve 232, the third 2-position 2-way magnetic exchange valve 242 and the fifth 2-position 2-way magnetic exchange valve 262 are all in the position of “closed”. The fourth 2-position 2-way magnetic exchange valve 252 is in the position of “open”, the fourth 2-position 4-way magnetic exchange valve 254 is in the position of “2”. Thus the second fixing platform 124 can be fixed by the locking means 126. Two seconds later, the first 2-position 2-way magnetic exchange valve 222, the second 2-position 2-way magnetic exchange valve 232, the third 2-position 2-way magnetic exchange valve 242 and the fifth 2-position 2-way magnetic exchange valve 262 will all switch to the position of “open”, the first 2-position 4-way magnetic exchange valve 224, the second 2-position 4-way magnetic exchange valve 234, the third 2-position 4-way magnetic exchange valve 244 and the fifth 2-position 4-way magnetic exchange valve 264 will all switch to the position of “2”. The working positions of all the magnetic exchange valves are shown in Table 1. Under the test condition above, the hydraulic control system 200 has five working routes.

The first working route:

The hydraulic oil is pumped by oil pump 204, hydraulic oil flows successively through the check valve 212, the first outlet A1 of 2-position 3-way magnetic exchange valve 214, the first outlet A1 of fourth 2-position 2-way magnetic exchange valve 252, the second outlet A2 of fourth 2-position 4-way magnetic exchange valve 254 and the hydraulic control one-way valve groups 256. Then the hydraulic oil in the hydraulic control one-way valve groups 256 will enter the rod-less cavity of first locking hydraulic cylinder 128 and the rod-less cavity of second locking hydraulic cylinder 130 respectively. The hydraulic oil in the rod cavity of first locking hydraulic cylinder 128 and the rod cavity of second locking hydraulic cylinder 130 flow successively through the hydraulic control one-way valve groups 256, the oil return port T2 of fourth 2-position 4-way magnetic exchange valve 254, the filtrator and the fuel tank 202. Complete the clamping on the top of the elastic bearing, making it fixed and unable to rotate.

The second working route:

The hydraulic oil is pumped by oil pump 204, hydraulic oil flows successively through the check valve 212, the first outlet A1 of 2-position 3-way magnetic exchange valve 214, the first outlet A1 of the first 2-position 2-way magnetic exchange valve 222, the second outlet A2 of the first 2-position 4-way magnetic exchange valve 224 and the rod-less cavity of compressing hydraulic cylinder 184. The hydraulic oil in the rod cavity of compressing hydraulic cylinder 184 flows successively through the oil return port T2 of the first 2-position 4-way magnetic exchange valve 224, the filtrator and the fuel tank 202. And then, applying pressure on the elastic bearing in the direction of X-axis is completed.

The third working route:

The hydraulic oil is pumped by oil pump 204, hydraulic oil flows successively through the check valve 212, the first outlet A1 of 2-position 3-way magnetic exchange valve 214, the first outlet A1 of the third 2-position 2-way magnetic exchange valve 242, the second outlet A2 of the third 2-position 4-way magnetic exchange valve 244 and the rod-less cavity of second bending hydraulic cylinder 166. The hydraulic oil in the rod cavity of second bending hydraulic cylinder 166 flows successively through the oil return port T2 of the third 2-position 4-way magnetic exchange valve 244, the filtrator and the fuel tank 202. And then, applying pressure on the elastic bearing in the direction of Y-axis is completed.

The fourth working route:

The hydraulic oil is pumped by oil pump 204, hydraulic oil flows successively through the check valve 212, the first outlet A1 of 2-position 3-way magnetic exchange valve 214, the first outlet A1 of the second 2-position 2-way magnetic exchange valve 232, the second outlet A2 of the second 2-position 4-way magnetic exchange valve 234 and the rod-less cavity of first bending hydraulic cylinder 164. The hydraulic oil in the rod cavity of first bending hydraulic cylinder 164 flows successively through the oil return port T2 of the second 2-position 4-way magnetic exchange valve 234, the filtrator and the fuel tank 202. And then, applying pressure on the elastic bearing in the direction of Z-axis is completed.

The fifth working route:

The hydraulic oil is pumped by oil pump 204, hydraulic oil flows successively through the check valve 212, the first outlet A1 of 2-position 3-way magnetic exchange valve 214, the first outlet A1 of fifth 2-position 2-way magnetic exchange valve 262, the second outlet A2 of fifth 2-position 4-way magnetic exchange valve 264, then simultaneously flow into the rod-less cavity of first twisting hydraulic cylinder 146 and the rod-less cavity of second twisting hydraulic cylinder 148. The hydraulic oil in the rod cavity of first twisting hydraulic cylinder 146 and the rod cavity of second twisting hydraulic cylinder 148 flow successively through the oil return port T2 of fifth 2-position 4-way magnetic exchange valve 264, the filtrator and the fuel tank 202. Finally the torque around the X-axis has been applied on the elastic bearing.

All the hydraulic cylinders work in this test process. The torsional stiffness characteristics of an elastic bearing around the X-axis, bending stiffness characteristics in the direction of the Y-axis, bending stiffness characteristics in the direction of the Z-axis and compression stiffness characteristics in the direction of the X-axis can all be calculated according to the magnitude of force and the deformation of elastic bearing.

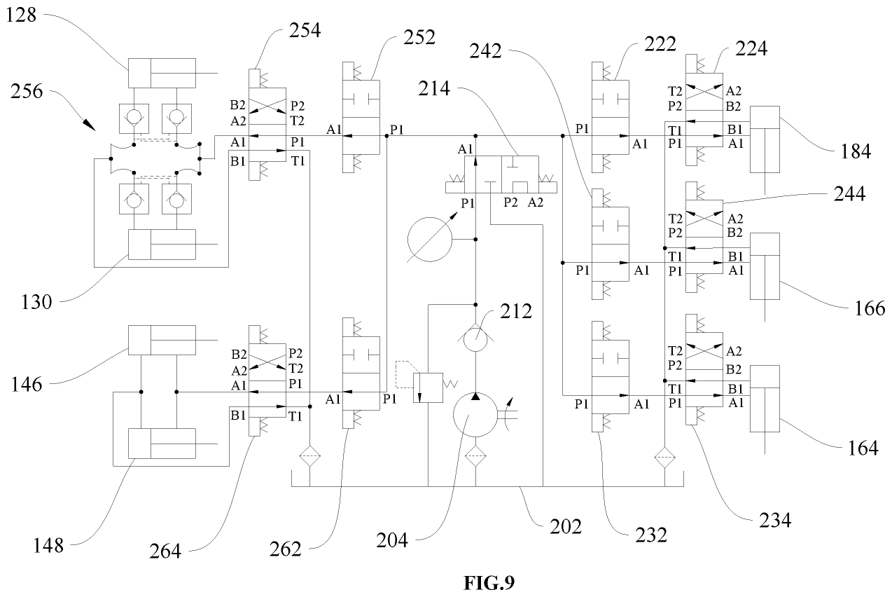

FIG. 9 illustrates the control schematic diagram of a hydraulic control system which has simultaneously began to withdraw the force on the elastic bearing after finishing the test above. When the hydraulic control system 200 has began to withdraw the force on the elastic bearing in the direction of the X-axis, the Y-axis, the Z-axis and around the X-axis, the first 2-position 4-way magnetic exchange valve 224, the second 2-position 4-way magnetic exchange valve 234, the third 2-position 4-way magnetic exchange valve 244 and the fifth 2-position 4-way magnetic exchange valve 264 will all switch from the position of “2” to “1”. Two seconds later, the position of fourth 2-position 4-way magnetic exchange valve 254 has been switched from “2” to “1”. Under the condition above, the hydraulic control system 200 has five unloading routes.

The first unloading route:

The hydraulic oil is pumped by oil pump 204, hydraulic oil flows successively through the check valve 212, the first outlet A1 of 2-position 3-way magnetic exchange valve 214, the first outlet A1 of the fifth 2-position 2-way magnetic exchange valve 262, the first outlet A1 of the fifth 2-position 4-way magnetic exchange valve 264, then simultaneously flow into the rod cavity of first twisting hydraulic cylinder 146 and the rod cavity of second twisting hydraulic cylinder 148. The hydraulic oil in the rod-less cavity of first twisting hydraulic cylinder 146 and the rod-less cavity of second twisting hydraulic cylinder 148 flow successively through the oil return port T1 of fifth 2-position 4-way magnetic exchange valve 264, the filtrator and the fuel tank 202. Finally, the force on the elastic bearing around the Z-axis can be removed.

The second unloading route:

The hydraulic oil is pumped by oil pump 204, hydraulic oil flows successively through the check valve 212, the first outlet A1 of 2-position 3-way magnetic exchange valve 214, the first outlet A1 of the second 2-position 2-way magnetic exchange valve 232, the first outlet A1 of the second 2-position 4-way magnetic exchange valve 234 and the rod cavity of first bending hydraulic cylinder 164. The hydraulic oil in the rod-less cavity of first bending hydraulic cylinder 164 flows successively through the oil return port T1 of the second 2-position 4-way magnetic exchange valve 234, the filtrator and the fuel tank 202. Finally, the force on the elastic bearing in the direction of Z-axis can be removed.

The third unloading route:

The hydraulic oil is pumped by oil pump 204, hydraulic oil flows successively through the check valve 212, the first outlet A1 of 2-position 3-way magnetic exchange valve 214, the first outlet A1 of the third 2-position 2-way magnetic exchange valve 242, the first outlet A1 of the third 2-position 4-way magnetic exchange valve 244 and the rod cavity of second bending hydraulic cylinder 166. The hydraulic oil in the rod-less cavity of second bending hydraulic cylinder 166 flows successively through the oil return port T1 of the third 2-position 4-way magnetic exchange valve 244, the filtrator and the fuel tank 202. Finally, the force on the elastic bearing in the direction of Y-axis can be removed.

The fourth unloading route:

The hydraulic oil is pumped by oil pump 204, hydraulic oil flows successively through the check valve 212, the first outlet A1 of 2-position 3-way magnetic exchange valve 214, the first outlet A1 of the first 2-position 2-way magnetic exchange valve 222, the first outlet A1 of the first 2-position 4-way magnetic exchange valve 224 and the rod cavity of compressing hydraulic cylinder 184. The hydraulic oil in the rod-less cavity of compressing hydraulic cylinder 184 flows successively through the oil return port T1 of the first 2-position 4-way magnetic exchange valve 224, the filtrator and the fuel tank 202. Finally, the force on the elastic bearing in the direction of X-axis can be removed.

The fifth unloading route:

The hydraulic oil is pumped by oil pump 204, hydraulic oil flows successively through the check valve 212, the first outlet A1 of 2-position 3-way magnetic exchange valve 214, the first outlet A1 of the fourth 2-position 2-way magnetic exchange valve 252, the first outlet A1 of the fourth 2-position 4-way magnetic exchange valve 254, the hydraulic control one-way valve groups 256, then simultaneously flow into the rod cavity of first locking hydraulic cylinder 128 and the rod cavity of second locking hydraulic cylinder 130. The hydraulic oil in the rod-less cavity of first locking hydraulic cylinder 128 and the rod-less cavity of second locking hydraulic cylinder 130, flow successively through the hydraulic control one-way valve groups 256, the oil return port T1 of fourth 2-position 4-way magnetic exchange valve 254, the filtrator and the fuel tank 202. Finally, the fixed force on the second fixing platform 124 can be removed.

The sixth working condition: no test for stiffness characteristics of an elastic bearing

As illustrated in Table 1, the 2-position 3-way magnetic exchange valve 214 is in the position of “closed”, the other magnetic exchange valves can be in any working position. Under the condition above, the hydraulic control system 200 has no working routes. If the oil pump 204 is still in working state at this time, the hydraulic oil will be transported to the 2-position 3-way magnetic exchange valve 214, which will lead to excessive pressure of the hydraulic control system 200. At this time, the overflow valve 213 will protect the hydraulic control system 200 from overload, which avoids the hidden danger caused by excessive pressure in hydraulic control system 200.

The above preferred embodiments are described for illustration only, and are not intended to limit the scope of the invention. It should be understood, for a person skilled in the art, that various improvements or variations can be made therein without departing from the spirit and scope of the invention, and these improvements or variations should be covered within the protecting scope of the invention.

1. A mechanical performance testing device, comprising a base, a fixing means, a first testing means and a second testing means, wherein the base is connected with the fixing means, each of the first testing means and the second testing means is configured to cause the fixing means to move in various directions.

2. The mechanical performance testing device of claim 1, wherein the base comprises a pedestal and a rotation axle, the pedestal is provided with a shaft block, one end of the rotation axle is installed on the shaft block by a thrust bearing, the other end of the rotation axle is connected with the fixing means, and the first testing means is connected with the rotation axle.

3. The mechanical performance testing device of claim 2, wherein the fixing means comprises a first fixing platform and a second fixing platform, the first fixing platform is in cooperation with the second fixing platform to form a fixing cavity, one side of the first fixing platform away from the second fixing platform is provided with a first spline shaft, the first fixing platform is connected in a transmission way with the rotation axle through the first spline shaft, and the second fixing platform is connected with the second testing means.

4. The mechanical performance testing device of claim 3, wherein one side of the second fixing platform away from the first fixing platform is provided with a second spline shaft, and the second fixing platform is connected in a transmission way with the second testing means through the second spline shaft.

5. The mechanical performance testing device of claim 4, wherein the fixing means also comprises a locking means, the locking means cooperates with the first testing means to implement a measurement of the torsional stiffness property, the locking means comprises a first locking hydraulic cylinder and a second locking hydraulic cylinder, with the first locking hydraulic cylinder and the second locking hydraulic cylinder being installed symmetrically on two sides of the second fixing platform for fixing the second fixing platform.

6. The mechanical performance testing device of claim 5, wherein the first testing means comprises a torsional testing unit, the torsional testing unit cooperates with the locking means to implement the measurement of the torsional stiffness property, the torsional testing unit comprises a turnplate and a twisting hydraulic cylinder, with the turnplate being installed on the rotation axle and being configured to be coaxial with the rotation axle, and with the twisting hydraulic cylinder being configured to apply torque on the turnplate for driving the rotation axle to rotate.

7. The mechanical performance testing device of claim 5, wherein the first testing means comprises a torsional testing unit, the torsional testing unit cooperates with the locking means to implement the measurement of the torsional property, the torsional testing unit comprises a turnplate, a first twisting hydraulic cylinder and a second twisting hydraulic cylinder, with the turnplate being installed on the rotation axle and being configured to be coaxial with the rotation axle, both of the first twisting hydraulic cylinder and the second twisting hydraulic cylinder apply torque on the turnplate to drive the rotation axle to rotate.

8. The mechanical performance testing device of claim 7, wherein the second testing means comprises a bending testing unit, the bending testing unit is installed on the second fixing platform and can be configured to drive the second fixing platform to move in a preset direction.

9. The mechanical performance testing device of claim 8, wherein the bending testing unit comprises a first bending hydraulic cylinder and a second bending hydraulic cylinder, the stretching direction of the first bending hydraulic cylinder and the stretching direction of the second bending hydraulic cylinder are mutually perpendicular, both of the two stretching directions are both perpendicular to the axial direction of the rotation axle, the second fixing platform can be driven by the first bending hydraulic cylinder and/or the second bending hydraulic cylinder to move in preset direction.

10. The mechanical performance testing device of claim 9, wherein the bending testing unit also comprises a mounting part, the first bending hydraulic cylinder and the second bending hydraulic cylinder both being installed on the mounting part, the mounting part and the second fixing platform are connected through the second spline shaft in a transmission way.

11. The mechanical performance testing device of claim 10, wherein the mounting part is provided with a first installation groove and a second installation groove, the first bending hydraulic cylinder connects with the mounting part by a first adapting piece, one end of the first adapting piece near the mounting part is located in the first installation groove, the second bending hydraulic cylinder connects with the mounting part by a second adapting piece, one end of the second adapting piece near the mounting part is located in the second installation groove.

12. The mechanical performance testing device of claim 11, wherein the second testing means also comprises a compression testing unit, the compression testing unit comprises a compressing hydraulic cylinder, one side of the mounting part away from the second fixing platform is connected with the compressing hydraulic cylinder through a flange.

13. A hydraulic control system applied to the mechanical performance testing device of claim 12, comprising a fuel tank, an oil pump and a control valves, and the fuel tank, the oil pump and the control valves connect successively, the control valves are used to control the extend-retract of the compressing hydraulic cylinder, the control valves are used to control the extend-retract of the first bending hydraulic cylinder, the control valves are used to control the extend-retract of the second bending hydraulic cylinder, the control valves are used to control the extend-retract of the first twisting hydraulic cylinder and the second twisting hydraulic cylinder, the control valves are used to control the extend-retract of the first locking hydraulic cylinder and the second locking hydraulic cylinder.

14. The hydraulic control system of claim 13, wherein the control valves comprise a check valve, a 2-position 3-way magnetic exchange valve, a first 2-position 2-way magnetic exchange valve and a first 2-position 4-way magnetic exchange valve, the oil pump, the check valve and the 2-position 3-way magnetic exchange valve connect successively, the 2-position 3-way magnetic exchange valve, the first 2-position 2-way magnetic exchange valve, the first 2-position 4-way magnetic exchange valve and the compressing hydraulic cylinder connect successively, the first 2-position 4-way magnetic exchange valve is used to control the extend-retract of the compressing hydraulic cylinder, the first 2-position 4-way magnetic exchange valve and the fuel tank are connected through a first oil return pipe.

15. The hydraulic control system of claim 14, wherein an overflow valve is installed on the outlet pipe of the check valve.

16. The hydraulic control system of claim 14, wherein the control valves also comprise a second 2-position 2-way magnetic exchange valve and a second 2-position 4-way magnetic exchange valve, the 2-position 3-way magnetic exchange valve, the second 2-position 2-way magnetic exchange valve, the second 2-position 4-way magnetic exchange valve and the first bending hydraulic cylinder connect successively, the second 2-position 4-way magnetic exchange valve is used to control the extend-retract of the first bending hydraulic cylinder, the second 2-position 4-way magnetic exchange valve and the fuel tank are connected through a second oil return pipe.

17. The hydraulic control system of claim 14, wherein the control valves also comprise a third 2-position 2-way magnetic exchange valve and a third 2-position 4-way magnetic exchange valve, the 2-position 3-way magnetic exchange valve, the third 2-position 2-way magnetic exchange valve, the third 2-position 4-way magnetic exchange valve and the second bending hydraulic cylinder connect successively, the third 2-position 4-way magnetic exchange valve is used to control the extend-retract of the second bending hydraulic cylinder, the third 2-position 4-way magnetic exchange valve and the fuel tank are connected through a third oil return pipe.

18. The hydraulic control system of claim 14, wherein the control valves also comprise a fourth 2-position 2-way magnetic exchange valve and a fourth 2-position 4-way magnetic exchange valve, the 2-position 3-way magnetic exchange valve, the fourth 2-position 2-way magnetic exchange valve and the fourth 2-position 4-way magnetic exchange valve connect successively, the first locking hydraulic cylinder and the second locking hydraulic cylinder both connect with the fourth 2-position 4-way magnetic exchange valve, the fourth 2-position 4-way magnetic exchange valve is used to control the extend-retract of the first locking hydraulic cylinder and the second locking hydraulic cylinder simultaneously, the fourth 2-position 4-way magnetic exchange valve and the fuel tank are connected through a fourth oil return pipe.

19. The hydraulic control system of claim 18, wherein the control valves also comprise a non-return valve group controlled by hydraumatic, the first locking hydraulic cylinder and the second locking hydraulic cylinder both connect with the fourth 2-position 4-way magnetic exchange valve through the non-return valve group, the non-return valve group is used to control the extend-retract of the first locking hydraulic cylinder and the second locking hydraulic cylinder simultaneously.

20. The hydraulic control system of claim 14, wherein the control valves also comprise a fifth 2-position 2-way magnetic exchange valve and a fifth 2-position 4-way magnetic exchange valve, the 2-position 3-way magnetic exchange valve, the fifth 2-position 2-way magnetic exchange valve and the fifth 2-position 4-way magnetic exchange valve connect successively, the first twisting hydraulic cylinder and the second twisting hydraulic cylinder both connect with the fifth 2-position 4-way magnetic exchange valve, the fifth 2-position 4-way magnetic exchange valve is used to control the extend-retract of the first twisting hydraulic cylinder and the second twisting hydraulic cylinder simultaneously, the fifth 2-position 4-way magnetic exchange valve and the fuel tank are connected through a fifth oil return pipe.
